(19) United States
(12) Patent Application Publication
(10) Pub. No.: US 2026/0312634 A1
(43) Pub. Date: Oct. 8, 2026

(54) A MIMO EQUALISER CIRCUIT FOR SUCCESSIVE INTERFERENCE CANCELLATION AND METHOD THEREFOR

(71) Applicant: AccelerComm Limited, Southampton (GB)

(72) Inventors: Siyao Lu, Southampton (GB); Robert Geoffrey Maunder, Southampton (GB); Xiaoyu Zhang, Southampton (GB); Mohammed El-Hajjar, Southampton (GB)

(21) Appl. No.: 19/479,356

(22) PCT Filed: May 16, 2024
(86) PCT No.: PCT/EP2024/035002

§ 371 Date: Oct. 28, 2025

(30) Foreign Application Priority Data
May 16, 2023 (GB) 2307296.0

(51) Int. Cl. H04B 7/0413; H04L 25/03

(52) U.S. Cl. CPC H04B 7/0413; H04L 25/03891

(57) ABSTRACT

A MIMO EQUALISER CIRCUIT FOR SUCCESSIVE INTERFERENCE CANCELLATION A MIMO equaliser circuit receives a covariance matrix, Rₗ, a first channel estimate matrix, H, and a first signal vector, y. An autocorrelation matrix calculation circuit calculates and outputs an autocorrelation matrix W based on Rₗ, and H. A matrix manipulation circuit receives and combines an inverted autocorrelation matrix, T and H and outputs a first G matrix. A first MMSE-IRC, circuit, combines the first G matrix and H and y and outputs a first equalised vector. A n-th MMSE-IRC-SIC stage receives a n-th set of equalised elements selected from a n-th equalised vector, a n-th G matrix, a n-th channel estimate matrix H, a n-th signal vector y, and outputs a ‘n+1’-th signal vector y, a ‘n+1’-th G matrix, and an ‘n+1’-th channel estimate matrix H; and a ‘n+1’-th MMSE-IRC circuit receives these and outputs a ‘n+1’-th equalised vector.

### FIELD OF THE INVENTION

The field of the invention relates to a Multiple-Input Multiple-Output (MIMO) equalisation circuit, a communication unit and a method for successive interference cancellation (SIC) in equalisers. The field of the invention is applicable to, but not limited to, MIMO equalisation for current and future generations of communication standards, particularly those that may employ successive interference cancellation (SIC) based Minimum Mean Square Error-Interference Rejection Combining (MMSE-IRC) equaliser circuits.

### BACKGROUND OF THE INVENTION

The most promising wireless technologies that can effectively boost the data transmission rate also improve system coverage and enhance link reliability. FIG. 1 shows an example Multiple-Input Multiple-Output (MIMO) communication system where the number of transmit antenna elements is equal to the number NT of transmit antenna ports, and the number of receive antenna elements is equal to the number N_{R} of receive antenna ports. Here, the information bits 102 to be transmitted are mapped to quadrature amplitude modulated (QAM) symbols by a QAM mapper 103. These QAM symbols are mapped to NL transmission layers by a layer mapper 104. Then a MIMO precoder 105 is used for projecting the QAM symbols on the transmission layers onto NT transmit antenna ports.

Explicitly, a precoding matrix generated by the precoder is applied to the QAM symbols on the transmission layers, where the precoding matrix has a first dimension of the number of transmission layers N_{L} and a second dimension of the number of transmit antenna ports NT, allowing the number of transmission layers in a MIMO communications system to be varied at run-time, even though the number of transmit and receive antenna elements are fixed for a given device. Specifically, the demodulation reference signal (DM-RS) symbols 132 from N_{L} layers are generated by a DM-RS generator 130 according to the reference signal configuration. The DM-RS symbols are projected onto NT transmit antenna ports by the precoder. The precoded symbols are mapped to the allocated physical resources by an RE mapper 106, followed by digital beamforming 107, orthogonal frequency division multiplex (OFDM) modulation 108, cyclic prefix (CP) insertion and analogue beamforming 109. Finally, a radio frequency (RF) stage 110 is used to deliver the signals to the set of transmit antenna elements, which may outnumber the NT transmit antenna ports in the case of beamforming, particularly in the downlink. Note that in some applications, some or all of precoding, digital beamforming and analogue beamforming may be omitted or merged together. Then the OFDM symbols are simultaneously transmitted by the transmit antenna elements 111 and arrive at the receive antenna elements 113, where the received signals are corrupted by the multipath fading channels 112, the noise 114, and the inter-cell or inter-user interference 133, as will be detailed in the sections below.

The RF stage 110 of the receiver collects the signals at the output of each receive antenna element 113, followed by the analogue beamforming 116, OFDM demodulation 117, CP removal and digital beamforming 118, which produce signals for the receive antenna ports, which may be outnumbered by the receive antenna elements. In the case of multi-user MIMO with beamforming in the uplink, each user that is co-scheduled onto the same time and frequency resource may be represented by a different subset of these receive antenna ports, perhaps with some residual interference from the other co-scheduled users. The number of receive antenna ports allocated to a particular user's received signal may be represented by N_{R}, which may vary at run-time, depending on how many co-scheduled users there are. For example, a receiver may have ‘64’ receive antenna elements, which are beamformed to provide ‘16’ receive antenna ports.

At times when there are, say, eight co-scheduled users, each of these users may be allocated a different set of N_{R}=2 of these receive antenna ports. At other times, there may be, say, sixteen co-scheduled users, with each being allocated N_{R}=1 of these receive antenna ports. Hence, the number of receive antenna ports N_{R} allocated to a particular user may vary at run-time. Note that in some applications, some or all of precoding, digital beamforming and analogue beamforming may be omitted or merged together. The demodulated frequency-domain signals of a particular user's N_{R} receive antenna ports are demapped by the RE demapper 119 and followed by operations of obtaining the channel estimate matrix H 121 by using the channel estimator 120 and obtaining the equalised signals 126 by the MIMO equaliser 125. Specifically, as illustrated in FIG. 1, the signals are mixed together by the multipath channels in the air, where the channel estimator tries to estimate the knowledge of the multipath fading channels 112 and the channel estimate matrix H 121 will be used by the MIMO equaliser 125 for recovering the mixed signals, where the operation of MIMO deprecoding has been integrated into the channel estimator 120.

The MIMO equalized signals on N_{L} layers 126 are then demapped into a symbol sequence by using a layer demapper 127. The symbol sequence is typically demapped into soft bits or hard bits 129 by a QAM demapper 128. Like hard bits, soft bits express what the most likely value of each bit is. However, unlike hard bits, soft bits also express how likely this bit value is. Soft bits are typically represented using Logarithmic Likelihood Ratios (LLRs), where LLR=In[Pr(bit=0)/Pr(bit=1)] in some applications and LLR=In[Pr(bit=1)/Pr(bit=0)] in some other applications. Specifically, the MIMO equalizer plays a significant role for combating intersymbol interference, wherein the minimum mean square error (MMSE) and MMSE interference rejection combining (MMSE-IRC) criterion-based MIMO equalisers have been considered the baseline MIMO equalizer in third generation partnership project (3GPP™) standards [1], as detailed in the sections below.

An MMSE-IRC equaliser can be used to separate a desired user's signal from interference and noise, where the MMSE-IRC equaliser has the advantage of low complexity and of not requiring channel estimates for the interfering users. However, an MMSE-IRC equaliser has the disadvantage of achieving limited spectral efficiency. Furthermore, other techniques have been proposed for suppressing the interference and noise, such as non-linear equalisation techniques, such as successive interference cancellation, SIC [2] or maximum likelihood equalisation [4]. Here, non-linear equalisers have the advantage of achieving improved spectral efficiency, but can have the disadvantage of high complexity and of requiring channel estimates for the interfering users.

### SUMMARY OF THE INVENTION

Examples of the present invention provide MMSE-IRC-SIC equalisers and methods for MMSE-IRC-SIC equalisation. In particular, examples of the present invention detail algorithms that are suited to hardware implementation, enabling high throughputs to be achieved in a cost-efficient manner. Specific example embodiments of the invention are set forth in the dependent claims. These and other aspects of the invention will be apparent from, and elucidated with reference to, the example embodiments described hereinafter.

In a first aspect, a multiple-input multiple-output, MIMO, equaliser circuit comprises: a first input that receives a covariance matrix, Rₗ, a second input that receives a first channel estimate matrix, H, and a third input that receives a first signal vector, y; an autocorrelation matrix calculation circuit, operably coupled to the first input and the second input, wherein the autocorrelation matrix calculation circuit is configured to calculate and output an autocorrelation matrix W based on the covariance matrix, Rₗ, and the first channel estimate matrix, H; a matrix inversion circuit, operably coupled to the autocorrelation matrix calculation circuit, configured to receive and invert the autocorrelation matrix, W, and output an inverted autocorrelation matrix, T; a matrix manipulation circuit, operably coupled to the matrix inversion circuit and the second input, wherein the matrix manipulation circuit is configured to receive and combine the inverted autocorrelation matrix, T, and the first channel estimate matrix, H, and output a first G matrix; a first minimum mean square error interference rejection combining, MMSE-IRC, circuit, operably coupled to the matrix manipulation circuit and the second input and third input, wherein the first minimum mean square error interference rejection combining, MMSE-IRC, circuit is configured to combine the first G matrix and the first channel estimate matrix, H, and the first signal vector, y, and output a first equalised vector; and one or more MMSE-IRC-SIC stages, wherein the first MMSE-IRC circuit is concatenated with the one or more MMSE-IRC-SIC stages to form a chain and wherein a n-th MMSE-IRC-SIC stage in the chain comprises: an n-th SIC circuit operably coupled to a n-th MMSE-IRC circuit, wherein the n-th SIC circuit is configured to:

receive an n-th set of one or more equalised elements that is selected from a n-th equalised vector, a n-th G matrix, a n-th channel estimate matrix H, a n-th signal vector y, and output a ‘n+1’-th signal vector y, a ‘n+1’-th G matrix, and an ‘n+1’-th channel estimate matrix H; and a ‘n+1’-th MMSE-IRC circuit operably coupled to the n-th SIC circuit, wherein the ‘n+1’-th MMSE-IRC circuit is configured to: receive the ‘n+1’-th signal vector y, the ‘n+1’-th G matrix, the ‘n+1’-th channel estimate matrix H, and output a ‘n+1’-th equalised vector. The MIMO equaliser circuit is further configured to output a final equalised vector x that is obtained by multiplexing an m-th equalised vector with each set of one or more equalised elements in a super-set comprising the first set of one or more equalised elements to an (m−1)-th set of one or more equalised elements and wherein a value of m varies between operations of the MIMO equaliser circuit at run-time. In this manner, linear MMSE-IRC processing is combined with non-linear processing, offering the advantage of interference rejection, low complexity, and improved equalisation capability. In this manner, when the final equalised vector x is obtained by multiplexing, the final equalised vector x is formed from the successive interference cancellation of the multiple layers, resulting in improved equalization performance. In this manner, when a value of m varies between operations of the MIMO equaliser circuit at run-time, the degree of successive interference cancellation applied is varied at run-time, allowing the configuration that maximises the performance of the MIMO equalizer to be selected depending on the present conditions.

In an optional example of the MIMO equalizer circuit, the MIMO equaliser circuit may further comprise a controller operably coupled to at least one circuit in the MIMO equaliser circuit. In this manner, the operation of the MIMO equalizer circuit may be flexibly controlled according to varying conditions.

In an optional example of the MIMO equalizer circuit, the MIMO equaliser circuit may further comprise a selection circuit operably coupled to the controller and configured to select the n-th set of one or more equalised elements from the n-th equalised vector under instruction by the controller and provide the n-th set of one or more equalised elements to the n-th SIC circuit. In this manner, the elements from the n-th equalised vector that would maximally improve the performance of the SIC operation may be selected.

In an optional example of the MIMO equalizer circuit, the controller may be configured to use a first set of one or more noise plus interference power value(s) corresponding to the n-th equalised vector to instruct the selection circuit of those elements of the n-th equalised vector to select. In this manner, the elements from the n-th equalised vector that would maximally improve the performance of the SIC operation may be selected according to a simple SINR metric.

In an optional example of the MIMO equalizer circuit, the n-th MMSE-IRC-SIC stage in the chain may further comprise a quantisation circuit operably coupled to and configured by the controller to replace each element in the n-th set of one or more equalised elements with a nearest quadrature amplitude modulated, QAM, symbol. In this manner, the performance of the SIC operation may be improved when the correct QAM symbol can be reliably identified.

In an optional example of the MIMO equalizer circuit, the controller may be configured to use a second set of one or more noise plus interference power value(s) corresponding to the n-th set of one or more equalised elements to replace each element in the n-th set of one or more equalised elements with the nearest QAM symbol. In this manner, SIC may be enabled or disabled as appropriate in order to maximise the performance of the SIC operation, depending on a simple SINR metric.

In an optional example of the MIMO equalizer circuit, both the autocorrelation matrix W, and the inverted autocorrelation matrix, T, may have a first dimension equal to a number of spatial streams, N_{R}, processed by the MIMO equaliser circuit and a second dimension equal to the number of spatial streams, N_{R}. In this manner, the MIMO equaliser circuit may support multiple spatial streams and multiple layers.

In an optional example of the MIMO equalizer circuit, the first signal vector, y, may have a length equal to the number of spatial streams, N_{R}, the first G matrix has a first dimension equal to a first number of MIMO layers N_{L} detected by the MIMO equaliser circuit and a second dimension equal to the number of spatial streams, N_{R}, the first channel estimate matrix, H, has a first dimension equal to the number of spatial streams, N_{R}, and a second dimension equal to the first number of MIMO layers, N_{L}. In this manner, the MIMO equaliser circuit may support multiple spatial streams and multiple layers.

In an optional example of the MIMO equalizer circuit, the ‘n+1’-th signal vector, y, may have a length equal to the number of spatial streams, N_{R}, the ‘n+1’-th G matrix has a first dimension equal to a ‘n+1’-th number of MIMO layers and a second dimension equal to the number of spatial streams, N_{R}, and the ‘n+1’-th channel estimate matrix, H, has a first dimension equal to the number of spatial streams, N_{R}, and a second dimension equal to the ‘n+1’-th number of MIMO layers, wherein the ‘n+1’-th number of MIMO layers is less than the n-th number of MIMO layers. In this manner, the MIMO equaliser circuit may support multiple spatial streams and multiple layers.

In an optional example of the MIMO equalizer circuit, the MIMO equaliser circuit may further comprise a controller operably coupled to at least one circuit in the MIMO equaliser circuit wherein the controller is configured to control an operation of the at least one circuit according to the dimensions of at least one matrix or vector input to or output from the at least one circuit, and wherein the number of spatial streams, N_{R}, and the first number of MIMO layers, N_{L}, varies at run-time. In this manner, the MIMO equaliser circuit may support transmissions from multiple transmitters employing different numbers of layers and may operate with beamforming combiners which allocate different numbers of spatial streams to recover the transmissions from different transmitters.

In an optional example of the MIMO equalizer circuit, the autocorrelation matrix calculation circuit may comprise: a Hermitian transpose circuit operably coupled to the second input and operable to perform a Hermitian transpose that converts the first channel estimate matrix, H, into a Hermitian transposed, H2, matrix; a first matrix multiplication circuit operably coupled to the second input and operably coupled to an output of the Hermitian transpose circuit and configured to combine and convert the first channel estimate matrix, H, and the Hermitian transposed, H2, matrix into a Hermitian H3 matrix; and a matrix addition circuit operably coupled to the first matrix multiplication circuit and configured to receive the Hermitian H3 matrix output from the first matrix multiplication circuit and receive the covariance matrix, Rₗ, via the first input wherein the matrix addition circuit is configured to add the Hermitian, H3, matrix to the covariance matrix, Rₗ, and generate the autocorrelation matrix W. In this manner, the autocorrelation matrix W may be calculated with low complexity.

In an optional example of the MIMO equalizer circuit, the matrix inversion circuit may comprise: a QR decomposition, QRD, circuit operably coupled to the controller and the autocorrelation matrix calculation circuit, wherein the QRD circuit is arranged to receive the autocorrelation matrix, W, and is configured by the controller to perform a QR decomposition on the autocorrelation matrix, W, and output an orthogonal unitary matrix, Q, and an upper triangular matrix, R; and a Gaussian elimination circuit operably coupled to the controller and the QRD circuit and configured by the controller to perform Gaussian elimination to convert the orthogonal unitary matrix, Q, and the upper triangular matrix, R, into the inverted autocorrelation matrix, T. In this manner, the the inverted autocorrelation matrix, T, may be calculated with low complexity.

In an optional example of the MIMO equalizer circuit, the Gaussian elimination circuit may be configured by the controller to perform a Hermitian variation of the Gaussian elimination. In this manner, the complexity of the Gaussian elimination may be reduced.

In an optional example of the MIMO equalizer circuit, the MIMO equaliser circuit may further comprise a first switch operably coupled to the controller and having a first switch input and a second switch input operably coupled to a covariance matrix generator circuit and an output operably coupled to the autocorrelation matrix calculation circuit; wherein the first switch is selectably controlled by the controller to output the covariance matrix R₁ to the autocorrelation matrix calculation circuit, wherein: the covariance matrix R₁ is provided by the first switch input in a first mode of operation; and the covariance matrix R₁ is provided by the second switch input in a second mode of operation, and wherein the covariance matrix generator circuit uses a noise power scalar to generate the second switch input. In this manner, interference rejection combining may be enabled or disabled at run-time, depending on which may be expected to provide the best signal reconstruction quality.

In an optional example of the MIMO equalizer circuit, the matrix manipulation circuit may further comprise: a second multiplication circuit operably coupled to the matrix inversion circuit and configured to receive the inverted autocorrelation matrix, T, and the Hermitian transposed H2 matrix, and generate the first G matrix by multiplying the inverted autocorrelation matrix, T, and the Hermitian transposed H2 matrix. In this manner, the first G matrix may be generated with low complexity.

In an optional example of the MIMO equalizer circuit, the n-th MMSE-IRC circuit may further comprise: a third multiplication circuit operable to convert the n-th signal vector y and the n-th G matrix into an n-th f vector; and a fourth multiplication circuit operable to convert the n-th G matrix and the n-th channel estimate matrix H into an n-th E matrix; and a division circuit operably coupled to the third multiplication circuit and the fourth multiplication circuit and configured to perform an element-wise division operation to convert the n-th f vector and the n-th E matrix into the n-th equalised vector. In this manner, the n-th equalised vector may be generated with low complexity.

In an optional example of the MIMO equalizer circuit, the matrix manipulation circuit may further comprise a fifth multiplication circuit operably coupled to the second multiplication circuit and the third input wherein the fifth multiplication circuit is configured to receive the first G matrix and the first channel estimate matrix H and output a P matrix obtained by multiplying the first G matrix and the first channel estimate matrix H, and wherein the MIMO equaliser circuit further comprises a noise variance calculation circuit operably coupled to each of the second multiplication circuit, the fifth multiplication circuit and the second input, wherein the noise variance calculation circuit is configured to receive the covariance matrix Rₗ, the first G matrix and the P matrix, and to generate a noise variance vector v therefrom. In this manner, the noise variance vector v may be generated with low complexity.

In an optional example of the MIMO equalizer circuit, the P matrix may have a first dimension equal to the first number of MIMO layers, N_{L}, and a second dimension equal to the first number of MIMO layers, N_{L}. In this manner, the MIMO equaliser circuit may support multiple spatial streams and multiple layers.

In a second aspect, a communication unit comprising the MIMO equaliser circuit according to the first aspect is described. In this manner, linear MMSE-IRC processing is combined with non-linear processing in the communication unit, offering the advantage of interference rejection, low complexity, and improved equalisation capability.

In a third aspect, a method for successive interference cancellation (SIC) in a multiple-input multiple-output, MIMO, equaliser circuit comprises: receiving a covariance matrix, Rₗ, at a first input; receiving a first channel estimate matrix, H, at a second input; receiving a first signal vector, y, at a third input; calculating and outputting, by an autocorrelation matrix calculation circuit, an autocorrelation matrix W based on the covariance matrix, Rₗ, and the first channel estimate matrix, H; inverting the autocorrelation matrix, W, by a matrix inversion circuit, and outputting an inverted autocorrelation matrix, T; combining the inverted autocorrelation matrix, T, and the first channel estimate matrix, H, by a matrix manipulation circuit, and outputting a first G matrix; combining, by a first minimum mean square error interference rejection combining, MMSE-IRC, circuit, the first G matrix and the first channel estimate matrix, H, and the first signal vector, y, and outputting a first equalised vector; and forming a chain by concatenating a first MMSE-IRC circuit with the one or more MMSE-IRC-SIC stages; receiving, by a n-th SIC circuit, an n-th set of one or more equalised elements that is selected from a n-th equalised vector, a n-th G matrix, a n-th channel estimate matrix H, a n-th signal vector y, and outputting a ‘n+1’-th signal vector y, a ‘n+1’-th G matrix, and an ‘n+1’-th channel estimate matrix H; receiving, by a ‘n+1’-th MMSE-IRC circuit, the ‘n+1’-th signal vector y, the ‘n+1’-th G matrix, the ‘n+1’-th channel estimate matrix H; outputting a ‘n+1’-th equalised vector; multiplexing an m-th equalised vector with each set of one or more equalised elements in a super-set comprising the first set of one or more equalised elements to an (m−1)-th set of one or more equalised elements, wherein a value of m varies between operations of the MIMO equaliser circuit at run-time; and outputting, in response thereto, a final equalised vector x.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the FIG's are illustrated for simplicity and clarity and have not necessarily been drawn to scale.

FIG. 1 illustrates a known schematic of an example physical layer uplink transceiver signal processing operations for an example of a MIMO system where the number of transmit antenna elements happens to be equal to the number NT of transmit antenna ports and the number of receive antenna elements happens to be equal to the number N_{R} of receive antenna ports.

FIG. 2 illustrates a representation of the covariance matrix examples from a MIMO equaliser.

FIG. 3 illustrates a MIMO equaliser circuit for the operation of an MMSE-IRC-SIC MIMO equaliser according to some examples of the invention.

FIG. 4 illustrates an MMSE-IRC-SIC circuit for an example embodiment of the MMSE-IRC-SIC MIMO equaliser according to some examples of the invention.

FIG. 5 illustrates an MMSE-IRC circuit for an example embodiment of the MMSE-IRC-SIC MIMO equaliser according to some examples of the invention.

FIG. 6 illustrates a table to show the simulation limits and simulation parameters for the operation of a MIMO equaliser according to some examples of the invention.

FIG. 7 illustrates an example simulation result for the operation of the MMSE-IRC-SIC MIMO equaliser according to some examples of the invention.

FIG. 8 illustrates a flow chart for an example embodiment of the MMSE-IRC-SIC MIMO equaliser according to some examples of the invention.

### DETAILED DESCRIPTION

As discussed above, an MMSE-IRC equaliser can be used to separate a desired user's signal from interference and noise. Other techniques have been proposed for this purpose, including non-linear equalisers, such as SIC [2] or the maximum likelihood equaliser [4]. In a comparison between an MMSE-IRC equaliser and a non-linear equaliser, the MMSE-IRC equaliser has the advantage of low complexity and of not requiring channel estimates for the interfering users, but has the disadvantage of limited spectral efficiency, particularly when the number of MIMO layers equals the number of receive antenna port. Conversely, the non-linear equaliser has the disadvantage of high complexity and of requiring channel estimates for the interfering users, but has the advantage of improved spectral efficiency, particularly when the number of MIMO layers equals the number of receive antenna port. A problem exists of how to achieve the best of both worlds, to design an equaliser that may be able to provide a number or all of these advantages and reduce or remove a number or all of these disadvantages, namely a low complexity, without the requirement of having channel estimates for the interfering users, while maintaining high spectral efficiency when the number of MIMO layers equals the number of receive antenna ports.

Examples of the present invention may address this problem by modifying an MMSE-IRC equaliser so that the modified and improved MMSE-IRC equaliser supports an interface with a non-linear equaliser, which performs SIC. In some examples the proposed solution adopts algorithms that are suited to hardware implementation, enabling high throughputs to be achieved in a cost-efficient manner. Before detailing the proposed MMSE-IRC-SIC equaliser, we begin by detailing an example implementation of an MMSE equaliser and an MMSE-IRC equaliser, without the use of SIC.

### Linear MMSE Equaliser

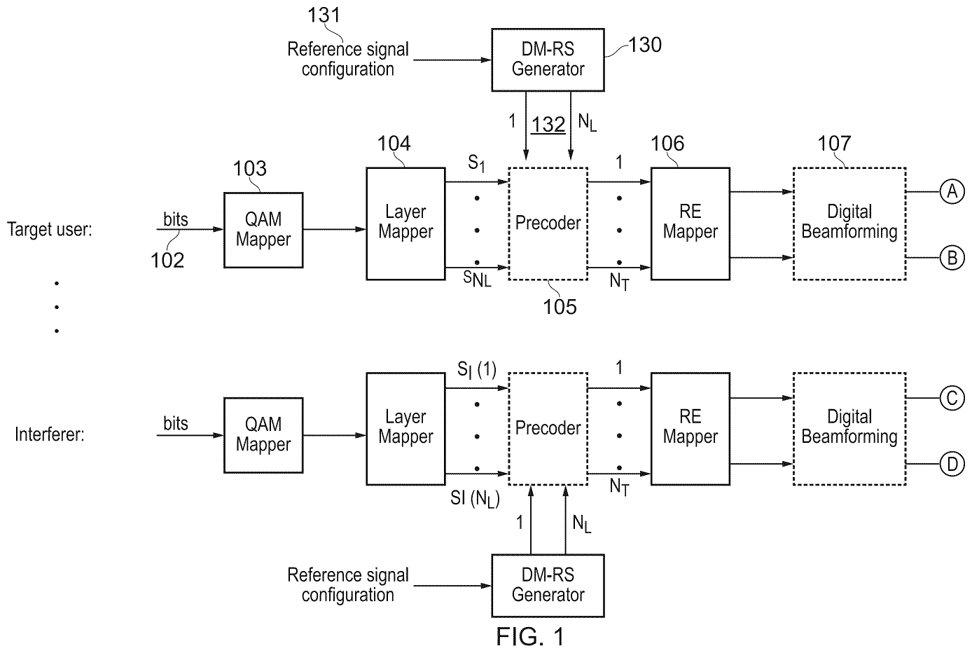

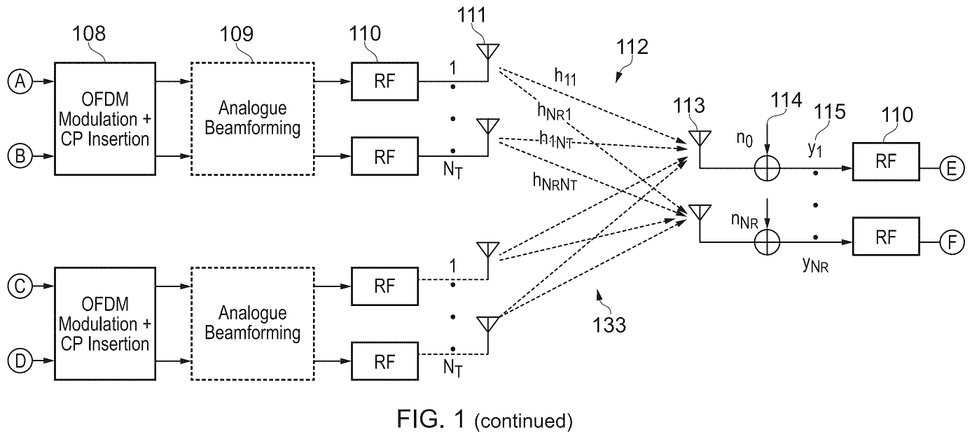

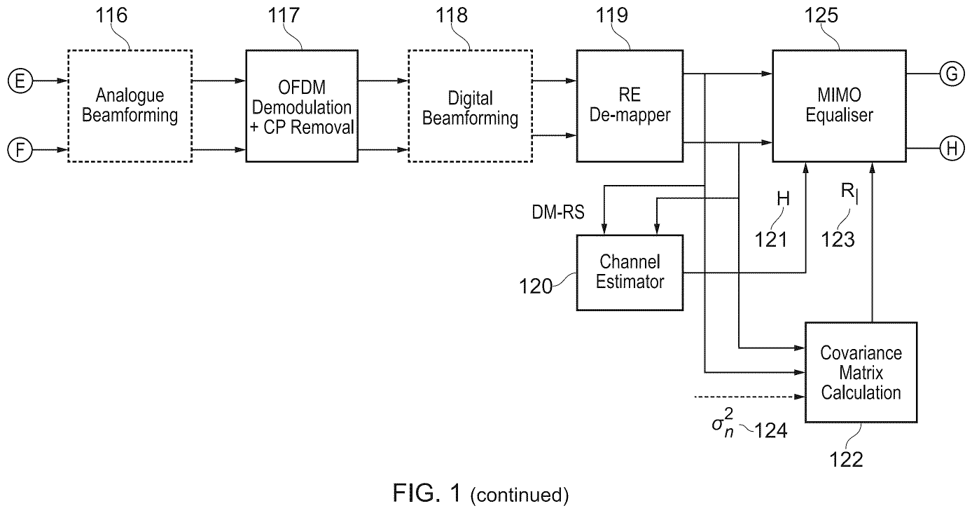

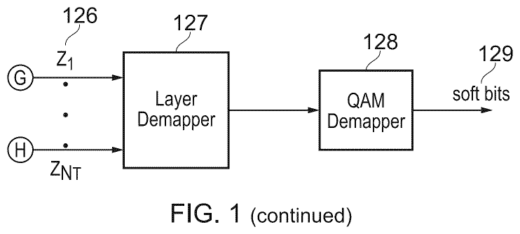

The MMSE criterion-based MIMO equaliser is based on the received signals from the receive antenna ports and channel estimates and aimed to get the optimized signal-to-noise ratio (SN_{R}) for the estimated signal ZMMSE. An MMSE equaliser circuit comprises a first input that accepts the received signal from receive antenna ports, a second input that accepts channel estimates, a third input that accepts noise power scalar and an output that provides the equalised signal ZMMSE. Considering an example MIMO system where the number of transmit antenna elements 111 happens to be equal to the number NT of transmit antenna ports and the number of receive antenna elements 113 happens to be equal to the number N_{R} of receive antenna ports as shown in FIG. 1, after the transmission over the fading channel, the frequency-domain received signal at a particular receiver can then be expressed as:

$$y = Hs + n , \qquad ( 1 )$$

$$where :$$

$$H = [ \begin{matrix}{h}_{11} & ⋯ & {h}_{1 {N}_{L}} \\ ⋮ & ⋱ & ⋮ \\ {h}_{{N}_{R} 1} & ⋯ & {h}_{{N}_{R} {N}_{L}}\end{matrix} ]$$

and H matrix represents the frequency-domain channel estimate, s=[s₁, s₂, . . . , s_{NL}]^{T} represents the symbol vectors transmitted through the N_{L} layers, y=[y₁, y₂, . . . , y_{NR}]^{T} represents the frequency-domain received observation signal, and n=[n₁, n₂, . . . , n_{NR}]^{T} is the noise vector included in the received observation. Note that in cases where the number of transmit or receive antenna elements is greater than the corresponding number of antenna ports owing to the use of beamforming, the channel matrix H can be considered to be an effective channel between the N_{L} transmission layers and the N_{R} receive antenna ports, as will be further detailed below. Here, the channel matrix H effectively consolidates the effect of MIMO precoding, transmit beamforming, OFDM modulation, time domain channel effects, OFDM demodulation and receive beamforming.

In a linear equaliser, the filtered signal vector f_{MMSE}=G_{MMSE}y is obtained by multiplying the received signal vector y with a filter matrix G_{MMSE}, followed by a parallel decision on all layers. When the MMSE equaliser is considered, the filter matrix G_{MMSE} is chosen such that the mean-square-error (MSE) between the transmitted signal vector s and its filtered signal vector f_{MMSE} is minimized. Specifically, the minimization problem for the MMSE equaliser can be formed as [2]

$${G}_{MMSE} = arg {min}_{{G}_{MMSE}} E [ {‖ s - {f}_{MMSE} ‖}^{2} ] . \qquad ( 2 )$$

Where: arg min{ } is the argument of the minimum, E[ ] is the expectation operation, and ∥·∥ is the Frobenius norm.

The minimization of Equation [1] yields the filter matrix as:

$${W}_{MMSE} = {HH}^{H} + {σ}_{n}^{2} I . \qquad ( 3 )$$

$${G}_{MMSE} = {H}^{H} {W}_{MMSE}^{- 1} .$$

where

$${σ}_{n}^{2}$$

is the noise variance, (·)^{M} denotes the Hermitian transpose of a vector or a matrix, I is an identity matrix of dimension (N_{R}×N_{R}) and W_{MMSE} is the autocorrelation matrix of the received signal vector.

When the MMSE criterion shown in Equation [2] is achieved, the decision statistics can be expressed as:

$${f}_{MMSE} = {G}_{MMSE} y = {G}_{MMSE} Hs + {G}_{MMSE} n . \qquad ( 4 )$$

Where: f_{MMSE}=[(f_{MMSE})₁, (f_{MMSE})₂, . . . , (f_{MMSE})_{NL}]^{T} is the filtered signal vector. Additionally, the filter vector (G_{MMSE}); for detecting the symbol sᵢ is given by

$${( {G}_{MMSE} )}_{i} = {H ( : , i )}^{H} {( {HH}^{H} + {σ}_{n}^{2} I )}^{- 1} . ( i = 1 , … , {N}_{L} ) \qquad ( 3 b )$$

where H(:,i) represents the i-th column vector of the channel estimate matrix. Then, by using Equation [3b], the filtered symbol (f_{MMSE}); can be written as:

$${( {f}_{MMSE} )}_{i} = {( {G}_{MMSE} )}_{i} H ( : , i ) {s}_{i} + {( {G}_{MMSE} )}_{i} {n}_{i} . ( i = 1 , … , {N}_{L} ) \qquad ( 4 b )$$

According to Equation [4b], the equalisation gain (μ_{MMSE}); and the variance (β_{MMSE}); of the filtered symbol (f_{MMSE}); can be expressed as:

$${( {μ}_{MMSE} )}_{i} = {( {G}_{MMSE} )}_{i} H ( : , i ) , \qquad ( 4 c )$$

$${( {β}_{MMSE} )}_{i} = {{σ}_{n}^{2} ( {G}_{MMSE} )}_{i} {( {G}_{MMSE} )}_{i}^{H} . ( i = 1 , … , {N}_{L} ) \qquad ( 4 d )$$

Consequently, the estimated QAM symbol (z_{MMSE}); for the transmitted symbol sᵢ at the i-th transmission layer can be rewritten as:

$${( {z}_{MMSE} )}_{i} = \frac{{( {f}_{MMSE} )}_{i}}{{( {μ}_{MMSE} )}_{i}} ( i = 1 , … , {N}_{L} ) \qquad ( 4 e )$$

and the noise variance (v_{MMSE}); which will be used to calculate soft bits can be rewritten as:

$${( {v}_{MMSE} )}_{i} = \frac{{( {β}_{MMSE} )}_{i}}{{\vert {( {μ}_{MMSE} )}_{i} \vert}^{2}} ( i = 1 , … , {N}_{L} ) \qquad ( 4 f )$$

The estimated vector constructed by (z_{MMSE}); expressed in Equation [4e] will be demapped into a sequence by the layer demapper and then will be demapped into soft bits or hard bits 129 by the QAM demapper. The soft bits are typically represented by using LLRs, where the noise variance (v_{MMSE}); in Equation [4f] will be used to calculate LLRs, which can be expressed as:

$$LLR = ln \frac{P ( bit = 0 )}{P ( bit = 1 )}$$

where P (bit=0) denotes the probability of bit equals to 0 and P (bit=1) denotes the probability of bit equals to 1 and the soft bits are expressed using LLRs.

For example, after having the equalised symbols in Equation [4e] and the noise variance in Equation [4f], if quadrature phase shift keying (QPSK) modulation where each symbol has two bits is used, it is possible to derive the corresponding two LLRs as

$${LLR}_{1} = \frac{4}{{( {v}_{MMSE} )}_{i}} Im ( {( {z}_{MMSE} )}_{i} )$$

$${LLR}_{2} = \frac{4}{{( {v}_{MMSE} )}_{i}} Re ( {( {z}_{MMSE} )}_{i} )$$

where LLR₁ is the LLR for the first bit in a QPSK symbol, LLR₂ is the LLR for the second bit in the QPSK symbol, and Re(·) and Im(·) are the real and imaginary parts of (·), respectively.

### MMSE-IRC Equaliser

With the evolution of electronic hardware and MIMO techniques, inter-cell or inter-user interference suppression techniques, whose application was previously limited by their large computational burden, may now be cost-effectively implemented in receivers. Specifically, interference rejection combining (IRC) is a linear combining technique that relies on multiple receive antenna ports and estimates of the interfering channels to project the received signals on a subspace in which the MSE is minimized [3]. IRC represents an add-on to the known minimum mean square error (MMSE) criterion. Compared with the MMSE criterion-based MIMO equaliser in Equation [3], the MMSE-IRC criterion based MIMO equaliser not only considers the noise, but also considers the inter-cell or inter-user interference as illustrated in FIG. 1, wherein the interference plus noise is estimated in the MMSE-IRC criterion based MIMO equaliser to get the optimized signal-to-interference-plus-noise ratio (SIN_{R}) for the estimated signal z_{IRC}.

Considering an example MIMO system where the number of transmit antenna elements 111 happens to be equal to the number NT of transmit antenna ports and the number of receive antenna elements 113 happens to be equal to the number N_{R} of receive antenna ports for both the target user and the interferers as shown in FIG. 1, after the transmission over the fading channel, the frequency-domain received signal at a particular receiver can then be expressed as

$$y = Hs + {H}_{I} {s}_{I} + n , \qquad ( 5 )$$

$$where :$$

$${H}_{I} = [ \begin{matrix}{h}_{I} ( 1 , 1 ) & ⋯ & {h}_{I} ( 1 , {N}_{L} ) \\ ⋮ & ⋱ & ⋮ \\ {h}_{I} ( {N}_{R} , 1 ) & ⋯ & {h}_{I} ( {N}_{R} , {N}_{L} )\end{matrix} ]$$

and H matrix represent the frequency-domain channel matrices for the target user, s=[s₁, s₂, . . . , s_{NL}]^{T} represents the symbol vector transmitted by the target user, Hₗ matrix represent the channel matrix and the transmitted symbols for the interferer, respectively, y=[y₁, y₂, . . . , y_{NR}]^{T} represents the frequency-domain received observation vector, and n=[n₁, n₂, . . . , n_{NR}]^{T} is the noise vector included in the received observation. Note that in cases where the number of transmit or receive antenna elements is greater than the corresponding number of antenna ports owing to the use of beamforming, the channel matrices H and Hₗ can be considered to be effective channels between the Ny transmission layers of the desired and interfering users and the N_{R} receive antenna ports, as will be further detailed below. Here, the channel matrices H and Hₗ effectively consolidate the effect of MIMO precoding, transmit beamforming, OFDM modulation, time domain channel effects, OFDM demodulation and receive beamforming. Note further that there is no requirement for the interfering user to be using the same system parameters as the desired user, or even using the same waveform. Indeed, the interference could be derived from any RF signal from any number of sources or users in a practical system.

The minimization formulation can be expressed as:

$${G}_{IRC} = arg {min}_{{G}_{IRC}} E [ {‖ s - {f}_{IRC} ‖}^{2} ] . \qquad ( 6 )$$

where: arg min{ } is the argument of the minimum, E[ ] is the expectation operation, and ∥·∥ is the Frobenius norm.

The minimization formulation in Equation [6] yields the MMSE-IRC filter G_{IRC} matrix as:

$${W}_{IRC} = {HH}^{H} + {R}_{I} \qquad ( 7 )$$

$${G}_{IRC} = {H}^{H} {W}_{IRC}^{- 1} ,$$

wherein H matrix represents the channel estimate for the target user, (·)^{H} denotes the Hermitian transpose of a vector or a matrix, covariance matrix R₁ 123 represents the covariance matrix of the interference plus noise and WIRC is the autocorrelation matrix of the received signal vector. Specifically, to obtain the MMSE-IRC criterion-based filter matrix as shown in Equation [7], the covariance matrix including the sources of inter-cell/inter-user interference and noise needs to be estimated. In the example of 3GPP N_{R}, the covariance matrix may be estimated from the demodulation reference symbol (DM-RS) subcarriers by following equations:

$${R}_{I} = \frac{1}{{N}_{SP}} \sum {R}_{IPN} \qquad ( 7 b )$$

$${R}_{IPN} = ( y - {Hs}_{DMRS} ) {( y - {Hs}_{DMRS} )}^{H} \qquad ( 7 c )$$

where the DM-RS symbols 132 s_{DMRS} are used to estimate the covariance matrix, and Nₛₚ is the number of DM-RS symbols within each averaging unit for different DM-RS patterns 131.

A skilled practitioner would recognise that the covariance matrix can be calculated using pilot symbols or other techniques in various MIMO applications besides 3GPP N_{R}. Furthermore, rather than averaging over various DM-RS signals, a skilled practitioner would recognise that other time domain or frequency domain interpolation techniques could be employed to obtain the covariance matrix Rₗ.

When the MMSE-IRC criterion is achieved, the decision statistics can be expressed as

$${f}_{IRC} = {G}_{IRC} y = {G}_{IRC} Hs + {G}_{IRC} ( {H}_{I} {s}_{I} + n ) . \qquad ( 8 )$$

where f_{IRC}=[(f_{IRC})₁, (f_{IRC})₂, . . . , (f_{IRC})_{NL}]^{T} is the filtered received signal vector.

Additionally, the filter vector (G_{IRC}); for detecting the symbol sᵢ is given by

$${{( {G}_{IRC} )}_{i} = {H ( : , i )}^{H} * {HH}^{H} + {R}_{I} )}^{- 1} \cdot ( i = 1 , … , {N}_{L} ) \qquad ( 7 d )$$

where H(:,i) represents the i-th column vector of the channel estimate matrix.

Then, by using Equation [3b], the filtered receive symbol (f_{IRC}); can be written as

$${( {f}_{IRC} )}_{i} = {( {G}_{IRC} )}_{i} H ( : , i ) {s}_{i} + {( {G}_{IRC} )}_{i} \overline{{n}_{ι}} \cdot ( i = 1 , … , {N}_{L} ) \qquad ( 8 b )$$

According to Equation [4b], the equalisation gain (μ_{IRC})ᵢ and the variance (β_{IRC})ᵢ of the filtered symbol (f_{IRC})ᵢ can be expressed as

$${( {μ}_{IRC} )}_{i} = {( {G}_{IRC} )}_{i} H ( : , i ) , \qquad ( 8 c )$$

$${( {β}_{IRC} )}_{i} = {( {G}_{IRC} )}_{i} {{R}_{I} ( {G}_{IRC} )}_{i}^{H} , ( i = 1 , … , {N}_{L} ) \qquad ( 8 d )$$

Consequently, the estimated QAM symbol (z_{IRC})ᵢ for the transmitted symbol sᵢ at the i-th transmission layer can be rewritten as

$${( {z}_{IRC} )}_{i} = \frac{{( {f}_{IRC} )}_{i}}{{( {μ}_{IRC} )}_{i}} ( i = 1 , … , {N}_{L} ) \qquad ( 8 e )$$

And the noise variance (v_{IRC}); which will be used to calculate soft bits can be rewritten as

$${( {v}_{IRC} )}_{i} = \frac{{( {β}_{IRC} )}_{i}}{{\vert {( {μ}_{IRC} )}_{i} \vert}^{2}} ( i = 1 , … , {N}_{L} ) \qquad ( 8 f )$$

The estimated vector constructed by (z_{IRC}); expressed in Equation [4e] will be demapped into a sequence by the layer demapper and then will be demapped into soft bits or hard bits 129 by the QAM demapper. The soft bits are typically represented by using LLRs, where the noise variance (v_{IRC}); in Equation [4f] will be used to calculate LLRs, which can be expressed as

$$LLR = ln \frac{P ( bit = 0 )}{P ( bit = 1 )}$$

where P (bit=0) denotes the probability of bit equals to 0 and P (bit=1) denotes the probability of bit equals to 1 and the soft bits are expressed using LLRs.

For example, after having the equalised symbols in Equation [8e] and the noise variance in Equation [8f], if QPSK modulation where each symbol has two bits is used, it is possible to derive the corresponding two LLRs as

$${LLR}_{1} = \frac{4}{{( {v}_{IRC} )}_{i}} Im ( {( {z}_{IRC} )}_{i} )$$

$${LLR}_{2} = \frac{4}{{( {v}_{IRC} )}_{i}} Re ( {( {z}_{IRC} )}_{i} )$$

where LLR₁ is the LLR for the first bit in a QPSK symbol, LLR₂ is the LLR for the second bit in the QPSK symbol, and Re(·) and Im(·) are the real and imaginary parts of (·), respectively.

### An MMSE-IRC-SIC MIMO Equaliser Implementation

In some examples of the invention, the inventors have proposed an MMSE-IRC-SIC equaliser that may be used to meet and exceed the detection reliability of the known MMSE-IRC criterion, which specifies the requirements for a linear combining technique that relies on multiple receive antenna ports and estimates of the interfering channels to project the received signals on a subspace in which the mean square error is minimised. In some examples, the proposed MMSE-IRC-SIC equaliser, may utilise several SIC stages and leads a hybrid detection scheme, where specifically a skilled practitioner would recognise whether a fully linear or partial linear and partial non-linear schemes should be selected or not based on different channel conditions.

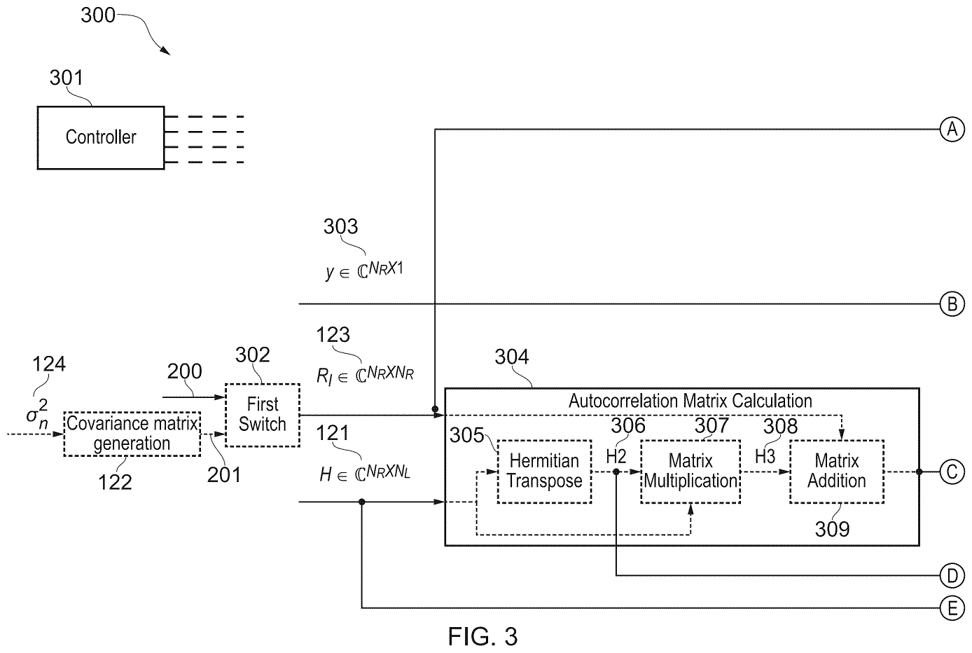

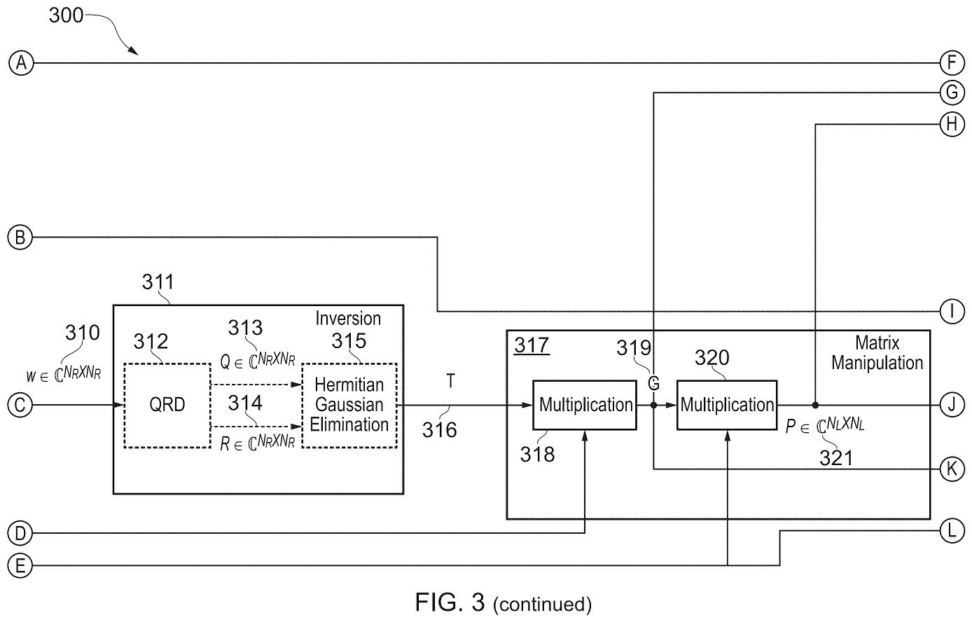

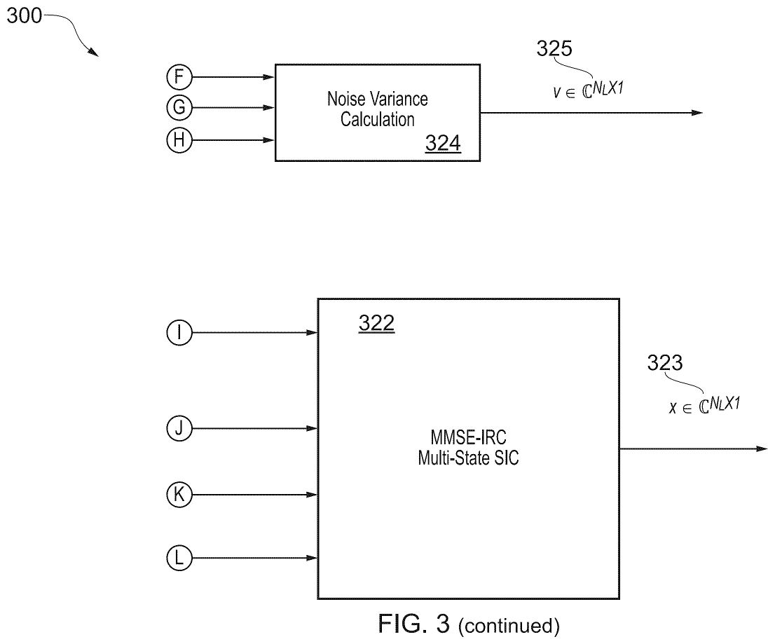

In the following discussions, the basic principles and operations for a MIMO equaliser circuit 300 based on FIG. 3, which in some applications perform the MMSE-IRC multi-stage SIC equaliser will be discussed, followed by discussions on specific functional blocks. Finally, an example simulation result will be presented. For the sake of simplicity, the subscript ‘_IRC’ is removed from all notations in the following discussion.

In accordance with some examples described herein, the MIMO equaliser circuit as illustrated in FIG. 3 comprising a controller 301, an autocorrelation matrix calculation circuit 304, a matrix inversion circuit 311, a matrix manipulation circuit 317, and a MMSE-IRC-SIC equaliser circuit 322 may be used to convert an input which is provided by a first signal vector y 303 of dimension (N_{R}×1), an input which is provided by a first channel estimate matrix H 121 of dimension (N_{R}×N_{L}) and an input which is provided by a covariance matrix R₁ 123 of dimension (N_{R}×N_{R}) into an output which provides a final equalised signal vector x 323 of dimension (N_{L}×1) and an output which provides an estimated noise variance vector v 325 of dimension (N_{L}×1), wherein a number of spatial streams N_{R} and a number of MIMO layers N_{L} varies between operations of the MIMO equaliser circuit at run-time. A skilled practitioner would recognise that the dimensions of all matrices could be swapped, such that rows become columns and vice versa. A skilled practitioner would readily recognise that some reordering of terms in the matrix expressions would be required but would give identical operation to that described in this discussion.

In some examples of the present invention where the number of spatial streams N_{R} and a number of MIMO layers N_{L} varies between operations of the MIMO equaliser circuit at run-time, the various blocks shown in FIG. 3 may operate under the direction of a controller 301. Here, the controller 301 may adapt the operation of each block according to the dimensions of the various matrices and vectors passed at the inputs and outputs of the block, which vary with the number of spatial streams N_{R} and the number of MIMO layers N_{L} at run-time. In other examples, the number of spatial streams N_{R} and the number of MIMO layers N_{L} may be fixed and may not vary between operations of the MIMO equaliser circuit at run-time. In this case, the operation of the various blocks shown in FIG. 3 may not vary at run-time and hence they may operate without the direction of the controller 301.

The autocorrelation matrix calculation circuit 304 as illustrated in FIG. 3 further comprising a Hermitian transpose circuit 305, a matrix multiplication circuit 307, and a matrix addition circuit 309 may be used to produce the autocorrelation matrix W 310 may be used to convert the input which is provided by the first channel estimate matrix H 121 of dimension (N_{R}×N_{L}) and the input which is provided by the covariance matrix R₁ 123 of dimension (N_{R}×N_{R}) into an output which is provided by the autocorrelation matrix W 310 of dimension (N_{R}×N_{R}).

Explicitly, substituting Equation [7] into Equation [8], yields:

$$\begin{matrix}f = {{H}^{H} ( {HH}^{H} + {R}_{I} )}^{- I} Hs + {{H}^{H} ( {HH}^{H} + {R}_{I} )}^{- 1} ( {H}_{I} {s}_{I} + n ) \\ = {H}^{H} {W}^{- 1} Hs + {H}^{H} {W}^{- 1} ( {H}_{I} {s}_{I} + n ) ,\end{matrix} \qquad ( 9 )$$

where the equalization gain matrix may be defined as:

$$P = {( {HH}^{H} + {R}_{I} )}^{- 1} H = {H}^{H} {W}^{- 1} H . \qquad ( 10 )$$

More specifically, in Equation [9], W=HH^{H}+R₁ denotes the autocorrelation matrix W 310 of the first signal vector y 303 in Equation [5], where the multiplication of the first channel estimate matrix H 121 and its Hermitian transposed H2 matrix 306 results in a Hermitian H3 matrix 308, and the covariance matrix R₁ 123 is also Hermitian according to the calculations in Equation [7b] and [7c], with the result that the autocorrelation matrix W 310 is Hermitian. The special Hermitian structure of the W matrix may be used to simplify the implementation of the matrix inversion circuit 311 shown in FIG. 3 and the details will be discussed later.

More explicitly, the matrix inversion circuit 311 as illustrated in FIG. 3 may be used to convert an input which is provided by the autocorrelation matrix W 310 of dimension (N_{R}×N_{R}) into an output which provides an inverted autocorrelation matrix T 316 of dimension (N_{R}×N_{R}).

In accordance with some examples described herein, in order to reduce the implementation complexity of the autocorrelation matrix inversion involved in the calculation of the G matrix 319 in Equation [7], a circuit for performing QR decomposition, QRD, with Hermitian Gaussian elimination-based matrix inversion may be used in the MIMO equaliser circuit 300 illustrated in FIG. 3. Explicitly, in the MIMO equaliser circuit 300, the matrix inversion circuit 311, as shown in FIG. 3, may comprise a QRD circuit 312 and a Hermitian Gaussian elimination circuit 315, where the QRD circuit 312 may be used to convert the autocorrelation matrix W 310 into an orthogonal unitary matrix Q 313 of dimension (N_{R}×N_{R}) and an upper triangular matrix R 314 of dimension (N_{R}×N_{R}), and the Hermitian Gaussian elimination circuit 315 may be used to convert the orthogonal unitary matrix Q 313 and the upper triangular matrix R 314 into the inverted autocorrelation matrix T 316. For the sake of a simplified analysis, the overall process of using QRD with Hermitian Gaussian elimination-based matrix inversion can be described as the following pseudo code:

Algorithm-1

Input: Autocorrelation matrix W 310
Output: Inverted autocorrelation matrix T 316
Step 1: Problem formulation
If an autocorrelation matrix W 310 of dimension (N_{R} × N_{R}) is invertible and T = W¹, the
following relationship may exist:
$W {W}^{- 1} = I \qquad ( 22 )$
Step 2: QR Decomposition on W matrix
From QR decomposition:
$QRT = I \qquad ( 23 )$
By applying Q^{H} on Equation [23], yields:
$R T = {Q}^{H} \qquad ( 24 )$
Note that owing to the unitary features of the Q matrix, it is guaranteed that Q^{H}. Q = I.
Step 3: Hermitian Gaussian elimination

Benefiting from the upper triangular structure of the upper triangular matrix R 314 and from the Hermitian structure of the autocorrelation matrix W 310 as discussed earlier, the inverted autocorrelation matrix T 316 can be calculated by using a Hermitian Gaussian elimination, wherein the Hermitian Gaussian elimination can be described as:

$$for i = 1 , … , {N}_{R}$$

$$for k = {N}_{R} , … , i$$

$${d}_{k} = {\sum }_{j = k + 1}^{{N}_{R}} {r}_{k , j} T ( j , i ) \qquad ( 25 )$$

$$T ( k , i ) = \frac{{Q}^{H} ( k , i ) - {d}_{k}}{{r}_{k , k}} \qquad ( 26 )$$

$$end$$

$$end$$

where (0.5N_{R}²+0.5N_{R}) number of operations are executed by Equation and during the Hermitian Gaussian elimination shown in the pseudo code. However, in a matrix inversion circuit based on the conventional Gaussian elimination described in the following pseudo code, N_{R}² number of operations are required.

### Conventional Gaussian Elimination:

$$for i = 1 , … , {N}_{R}$$

$$for k = {N}_{R} , … , i$$

$${d}_{k} = {\sum }_{j = k + 1}^{{N}_{R}} {r}_{k , j} T ( j , i ) \qquad ( 27 )$$

$$T ( k , i ) = \frac{{Q}^{H} ( k , i ) - {d}_{k}}{{r}_{k , k}} \qquad ( 28 )$$

$$end$$

$$end$$

More specifically, the autocorrelation matrix W 310 or inverted autocorrelation matrix T 316 always have the Hermitian property and an example of the inverted autocorrelation matrix T 316 of dimension (3×3) can be expressed as

$$T = [ \begin{matrix}{t}_{1 , 1} & {t}_{2 , 1}^{*} & {t}_{3 , 1}^{*} \\ {t}_{2 , 1} & {t}_{2 , 2} & {t}_{3 , 2}^{*} \\ {t}_{3 , 1} & {t}_{3 , 2} & {t}_{3 , 3}\end{matrix} ] . \qquad ( 29 )$$

From the Hermitian structure shown in Equation [29], calculating the lower triangular elements of the inverted autocorrelation matrix T 316 is enough for obtaining a full matrix, where the upper off-diagonal elements can be obtained by calculating the conjugate transpose of the lower off-diagonal elements. Note that in some examples, the invention may always use the lower-complexity Hermitian Gaussian elimination in the matrix inversion circuit. A skilled practitioner would recognise that a conventional Gaussian elimination can be used in place of the Hermitian Gaussian elimination, at the cost of higher latency, higher power consumption and/or hardware complexity.

Furthermore, the matrix manipulation circuit 317 illustrated in FIG. 3 may be used to convert an input which is provided by the inverted autocorrelation matrix T 316 of dimension (N_{R}×N_{R}) and an input which is provided by a first channel estimate matrix H 121 of dimension (N_{R}×N_{L}) into an output which provides a first G 319 matrix of dimension (N_{L}×N_{R}) and an output which provides a P matrix 321 of dimension (N_{L}×N_{L}).

Explicitly, the first G matrix 319 is obtained by following the signal processing in Equation [7], and the P matrix 321 is obtained by Equation [10].

In accordance with the inventive concepts of the invention, the MMSE-IRC-SIC equaliser detects the N_{L} IQ symbols in multiple stages, where each stage detects one or more MIMO layers having not been detected yet. After the detection at a stage, the interference of the detected MIMO layers on the others having not been detected are cancelled based on the SIC principles.

In accordance with some examples described herein, the MMSE-IRC-SIC equaliser circuit 322 as illustrated in FIG. 3 may be used to convert an input which is provided by the first signal vector y 303 of dimension (N_{R}×1), an input which is provided by the first channel estimate matrix H 121 of dimension (N_{R}×N_{L}) and another input which is provided by the first G matrix 319 of dimension (N_{L}×N_{R}) into an output which provides a final equalised vector x 323 of dimension (N_{L}×1).

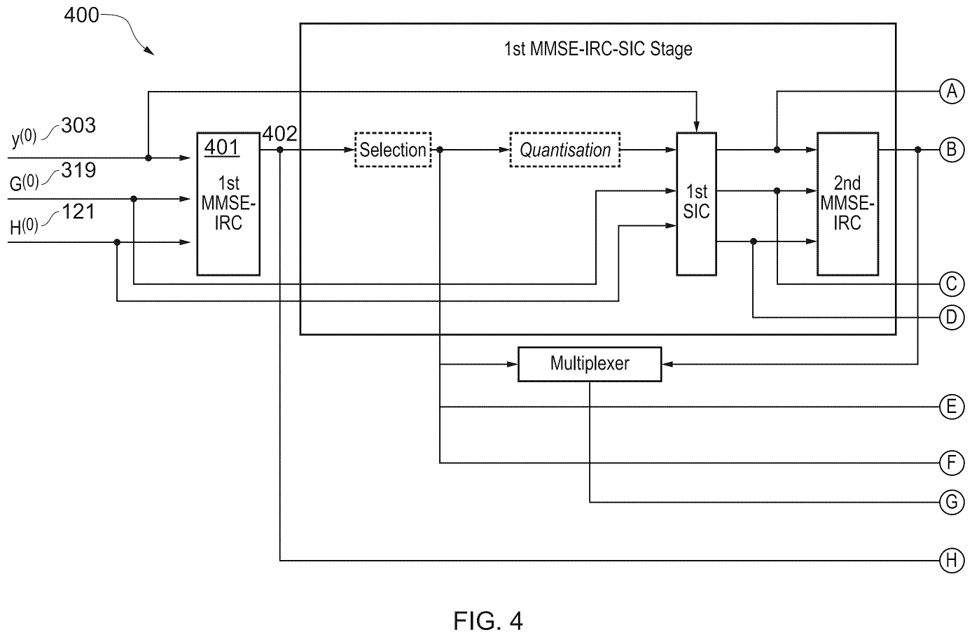

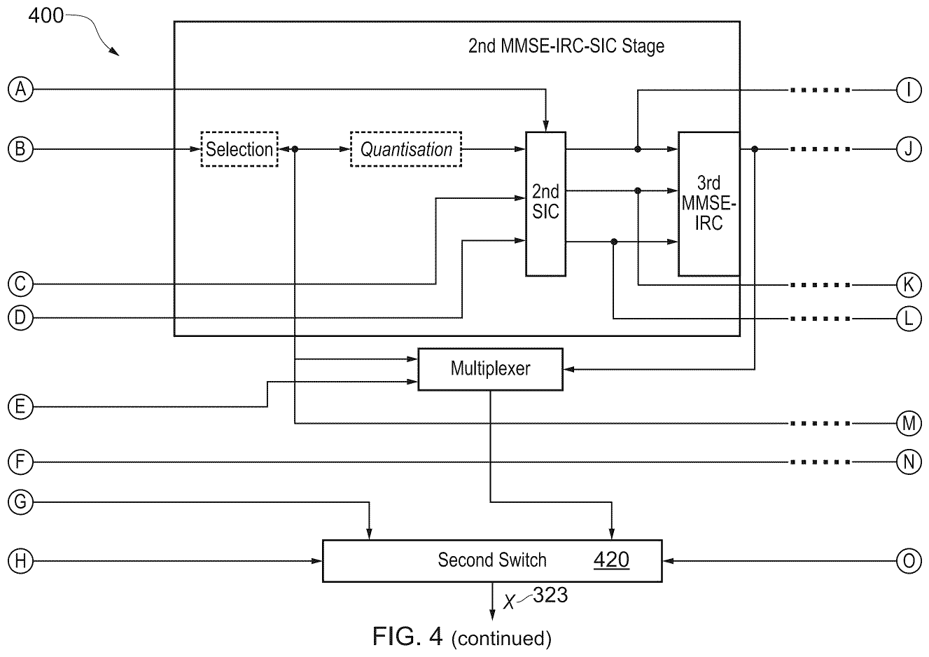

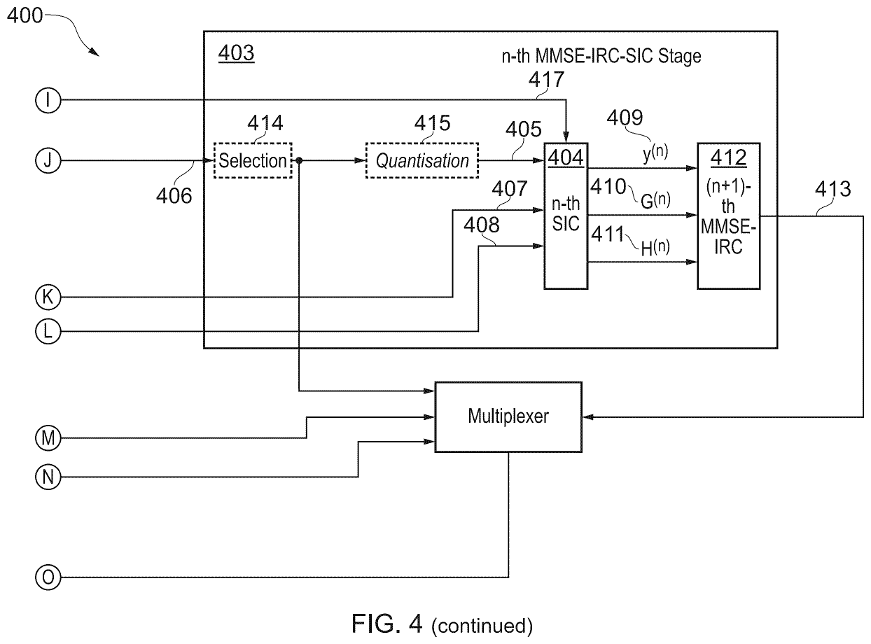

More specifically, the MMSE-IRC-SIC equaliser circuit 322 further comprises a series of successive MMSE-IRC circuits and SIC circuits, which form a chain. Here, each SIC circuit is paired with an MMSE-IRC circuit, in order to form an MMSE-IRC-SIC stage. By way of illustration, a first MMSE-IRC circuit 410 and several MMSE-IRC-SIC stages as shown in FIG. 4, wherein the first MMSE-IRC circuit 401 may be used to convert an input that is provided by the first signal vector y 303 of dimension (N_{R}×1), an input that is provided by the first G matrix 319 of dimension (N_{L}×N_{R}), and an input that is provided the first channel estimate matrix H 121 of dimension (N_{R}×N_{L}) into an output that is provided by a first equalised vector 402 of dimension (N_{L}×1). Furthermore, the MMSE-IRC-SIC stages as shown in FIG. 4 are concatenated to form a detection chain, wherein the n-th MMSE-IRC-SIC stage 403 in the chain further comprises an n-th SIC circuit 404 and an (n+1)-th MMSE-IRC circuit 412. More explicitly, the n-th SIC circuit 404 shown in FIG. 4 may be used to convert an n-th equalised element 405 that is taken from the (N_n×1) n-th equalised vector 406, an (N_n×N_{R}) n-th G matrix 407, and an (N_{R}×N_n) n-th channel estimate matrix H 408 into an (N_{R}×1) (n+1)-th signal vector y 409, an (N_n1×N_{R}) (n+1)-th G matrix 410, and an (N_{R}×N_n1) (n+1)-th channel estimate matrix H 411, where N_n and N_n1 represent an n-th number of MIMO layers and an (n+1)-th number of MIMO layers, respectively. The details of how the blocks in FIG. 4 work will be discussed later. In some examples, the detection chain may comprise a number M of MMSE-IRC-SIC stages and the index n may adopt a value in the range 1 to M and be used to index a particular one of the MMSE-IRC-SIC stages. In other examples, the index n may adopt each value in the range 1 to M and may be used to index each of the MMSE-IRC-SIC stages in turn. In some examples where each MMSE-IRC-SIC stage operates on a different one of the N_{L} layers, the number M of MMSE-IRC-SIC stages may equal N_{L}−1. In other examples, some of the MMSE-IRC-SIC stages may operate on more than one of the N_{L} layers and the number M of MMSE-IRC-SIC stages may be less than N_{L}−1.

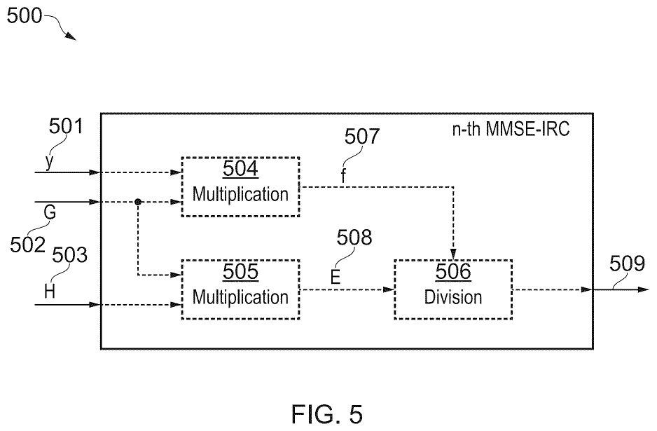

Here, the internal operation of the n-th MMSE-IRC circuit 500 is illustrated in FIG. 5, which comprises a pair of multiplication circuits and a division circuit 506. The first multiplication circuit 504 may be used to convert an n-th signal vector y 501 of dimension (N_{R}×1), and the n-th G matrix 502 into an n-th f vector 507 of dimension (N_{R}×1) as detailed in Algorithm-2. The second multiplication circuit 505 may be used to convert the n-th G matrix 502 and the n-th channel estimate matrix H 503 into an (Nₙ×Nₙ) n-th E matrix 508. Finally, the division circuit 506 may be used to perform an element-wise division operation and to convert the n-th f vector 507 and the n-th E matrix 508 into the n-th equalised vector 509, where the details of the blocks in FIG. 5 will be discussed in Algorithm-2 later.

In accordance with some examples described herein, the n-th MMSE-IRC-SIC stage 403 in the chain further comprises a selection circuit 414 as shown in FIG. 4, which is operably coupled to the controller 301 and wherein the controller 301 is operable to select and provide an n-th equalised element 405 from the n-th equalised vector 406 by measuring the reliabilities of the elements in the n-th equalised vector 406 based on Equation in Algorithm-2 for further improving the detection reliability at the cost of a slightly higher hardware requirement, a slightly higher power consumption and a slightly higher latency. A skilled practitioner would recognise that the controller may operably control the selection circuit 414 perform a sorting operation when the SINR values corresponding to the n-th equalised vector 406 is sufficiently diverse that the sorting operation in the selection circuit 414 can be expected to provide a reliable selection of the n-th equalised element. Alternatively, the n-th equalised element value may be provided by the first or an arbitrary equalised element of the n-th equalised vector when the selection circuit 414 is omitted or when disabling the selection circuit 414.

In accordance with some examples described herein, the n-th MMSE-IRC-SIC stage 403 in the chain further comprises a quantisation circuit 415 as shown in FIG. 4, which is optional and operable to quantise and replace each element in the n-th set of one or more equalised elements with a nearest QAM constellation point that has the least Euclidean distance with each equalised element, for further improving the detection reliability at the cost of a higher power consumption and a higher latency. A skilled practitioner would recognise that the quantisation circuit 415 controlled by the controller 301 may be operably performed when the channel SNR is sufficient such that the quantisation operation can be expected to provide a reliable decision of the n-th equalised element, and that the same n-th equalised element value without quantisation may be maintained when disabling the quantisation circuit 415 or when the quantisation circuit 415 is omitted.

In some examples of the invention, let us assume that the MMSE-IRC-SIC equaliser consists of N_{L} detection stages in the chain, which further comprise the first MMSE-IRC circuit and up to (N_{L}−1) MMSE-IRC-SIC stages. A skilled practitioner may recognise that less than (N_{L}−1) MMSE-IRC-SIC stages may be used in the case of detecting more than one of the equalised elements at each stage. At the n-th MMSE-IRC-SIC stage 403, one or more most reliable MIMO layers are operably provided by the selection circuit 414. FIG. 4 provides an example of only one most reliable user is operably provided at each stage, where at the n-th MMSE-IRC-SIC stage 403 shown in FIG. 4, the most reliable MIMO layer kₙ, which is operably provided by the selection circuit 414, has been detected, and the channel impulse response (CIR) signature of the kₙ layer is denoted by h⁽ⁿ⁾, which is obtained by taking the kₙ th column of the (n−1)-th channel estimate matrix H. Furthermore, let after the n-th MMSE-IRC-SIC stage 403 the CIR signatures of the MIMO layers having not been detected be collected in the n-th channel estimate matrix H 408, which in this example is denoted as H (n). Let the first channel estimate matrix H 121 be denoted as H⁽⁰⁾, the first signal vector y 303 be denoted as y⁽⁰⁾, which is provided in Equation [5], and the first G matrix 319 be denoted as G⁽⁰⁾. Then, the MMSE-IRC-SIC equaliser illustrated in FIG. 4 can be described as follows:

Algorithm-2

```
Initialisation: y⁽⁰⁾, H⁽⁰⁾, G⁽⁰⁾, D⁽⁰⁾ = I_{NL} - G⁽⁰⁾H⁽⁰⁾, E⁽⁰⁾ = G⁽⁰⁾H⁽⁰⁾
Detection: for n = 1, 2, ... , N_{L},
    1) Forming decision variables by using the n-th MMSE-IRC circuit:
        ${f}^{( n )} = {G}^{( n - 1 )} {y}^{( n - 1 )} \qquad ( 30 )$
        ${z}^{( n )} ( i ) = \frac{{f}^{( n )} ( i )}{{E}^{( n - 1 )} ( i , i )} ( i = 1 , 2 , … , {N}_{L} - n + 1 ) \qquad ( 31 )$
        Where the E matrix in Equation [31] is obtained based on Equation [10] and
        E⁽ⁿ⁻¹⁾(i, i) is the (i, i)th diagonal entry of E⁽ⁿ⁻¹⁾ = G⁽ⁿ⁻¹⁾H⁽ⁿ⁻¹⁾, the f vector in
        Equation [30] is obtained via the multiplication circuit of the n-th MMSE-IRC circuit
        as illustrated in FIG. 5 and f⁽ⁿ⁾(i) is an i-th element of the f vector, and z⁽ⁿ⁾(i) in
        Equation [31] is an i-th equalised element of the n-th equalised vector and is
        obtained via the division circuit as illustrated in FIG. 5.
    2) Determine the one or more most reliable MIMO layers by using the optional
        selection circuit: For the MIMO layers k₁, k₂, ... , K_{NL-n+1} that have not been
        detected, compute their reliabilities according to Equation [32],
        ${L}_{k} = {D}^{- 1} ( k , k ) \vert {z}^{( n )} ( k ) \vert \qquad [ 32 ]$
        sort a set of values {L1, L₂, ... , L_{NL-n+1}} obtained by Equation [32] in a descending
        order and find the one or more most reliable MIMO layers by selecting the first or
        the first several MIMO layers having higher reliabilities. Specifically, in the
        example like FIG. 4 where only a single layer is detected at the n-th detection
        stage, the most reliable layer kn is obtained by using kₙ = arg max{L₁, L₂, ... ,
        L_{NL-n+1}}. Then get the n-th equalised element that is represented as z(n) from the
        n-th equalised vector z⁽ⁿ⁾ that is obtained by Equation [31]. D⁻¹ (k, k) in Equation
        [32] is the inverse of the (i,i)-th entry of matrix D.
        Note that the selection circuit is optional, where the alternative is for the n-th
        equalised element z(n) to be provided by the first or an arbitrary element of the n-
        th equalised vector z⁽ⁿ⁾
    3) Quantisation of the one or more most reliable MIMO layers by using the
        quantisation circuit:
        ${z}_{quant} ( n ) = Quant ( z ( n ) ) \qquad [ 33 ]$
        Where: z_quant(n) represents one of quantised equalised symbols at the n-th
        MMSE-IRC-SIC stage.
        Note that the quantisation circuit is optional, where Zquant (n) = z(n) will be
        provided in this case.
    4) Interference cancellation by using the n-th SIC circuit:
        ${y}^{( n )} = {y}^{( n - 1 )} - {h}^{( n )} {z}_{quant} ( n ) \qquad [ 34 ]$
    5) Update matrices:
        $Perm = {I}_{N L - n + 1} \qquad [ 35 ]$
        Perm (:, kₙ) = [] [36] delete the column corresponding to the layer detected
        where, [] indicates that the corresponding column will be deleted and set as an
        empty column.
        ${G}^{( n )} = {( P e r m )}^{T} [ {G}^{( n - 1 )} + \frac{{G}^{( n - 1 )} {h}^{( n )} {g}^{( n - 1 )}}{{D}^{( n - 1 )} ( {k}_{n} , {k}_{n} )} ] \qquad [ 37 ]$
        ${H}^{( n )} = {H}^{( n - 1 )} Perm \qquad [ 38 ]$
        ${D}^{( n )} = I - {G}^{( n )} {H}^{( n )} \qquad [ 39 ]$
```

In some examples like FIG. 4 where a single MIMO layer is detected at each stage, in Equation [37], D⁽ⁿ⁻¹⁾ (kₙ, kₙ) is the (kₙ, kₙ)-th entry of D⁽ⁿ⁻¹⁾, while h⁽ⁿ⁾ is the kₙ-th column vector of the n-th channel estimate matrix H, g⁽ⁿ⁻¹⁾ is the kₙ-th row vector of the G⁽ⁿ⁻¹⁾ matrix. Furthermore, the n-th channel estimate matrix H that is denoted as H⁽ⁿ⁾ is obtained from the (n−1)-th channel estimate matrix H that is denoted as H⁽ⁿ⁻¹⁾ by deleting the column vector h⁽ⁿ⁾ corresponding to the MIMO layer detected at the n-th detection stage, and Perm is a permutation matrix obtained from an identity matrix I_{NL-n+1} after removing the column corresponding to the MIMO layer having been detected.

In other examples where more than one MIMO layer is detected at the n-th detection stage, the operation of matrices update in Step (5) of Algorithm-2 will be repeated for all MIMO layers that have been detected at the n-th detection stage.

In accordance with some examples described herein, two switches may be optionally applied in the MIMO equaliser circuit 300 as illustrated in FIG. 3-FIG. 4, wherein the first switch 302 each supports two modes of operation, and the second switch 420 supports up to N_{L} modes of operation under the direction of the controller 301. Specifically, in some examples like FIG. 4 where only a single MIMO layer is detected at the n-th detection stage, the second switch 420 is operable to support N_{L} modes of operation under the direction of the controller 301. In other examples where more than one MIMO layer is detected at the n-th detection stage, the second switch 420 is operable to support less than Ny modes of operation under the direction of the controller 301.

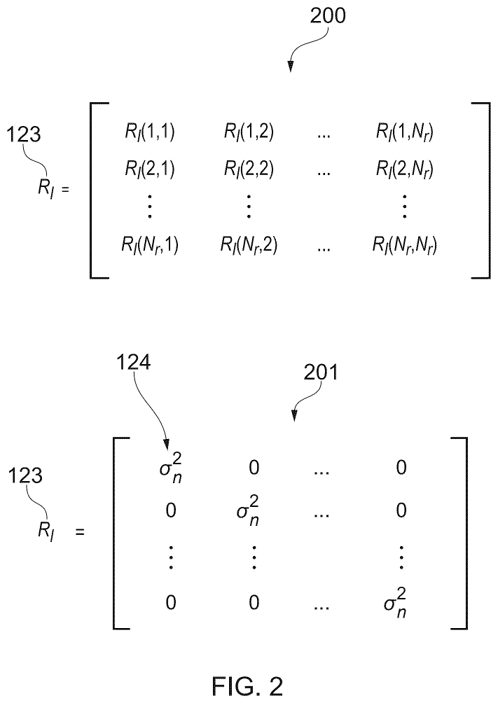

More explicitly, as shown in FIG. 3, the first switch 302 supports a first mode of operation wherein the covariance matrix input as shown in the left-hand side example 200 in FIG. 2 is used for equalisation following the MMSE-IRC criterion and wherein the first switch 302 optionally supports a second mode of operation wherein the covariance matrix shown in the right-hand side example 201 in FIG. 2 is generated by the covariance matrix generation circuit 122 from the input of noise power scalar 124 and used for equalisation following the MMSE criterion under the direction of the controller 301. The input of noise power scalar 124 is optional, and a covariance matrix generation circuit 122 as shown in FIG. 3 is required for calculating a diagonal covariance matrix as seen in the right-hand side example 201 in FIG. 2.

Furthermore, the second switch 420 shown in FIG. 4 is operable to provide the final equalised vector x 323 and optionally support up to N_{L} modes of operation, where the final equalised vector x 323 is obtained by multiplexing the m-th equalised vector with an equalised element set that comprises the first equalised element to the (m−1)-th equalised element, and the value of m varies between operations of the MIMO equaliser circuit 300 at run-time. A skilled practitioner may recognise that it is beneficial to select the m value flexibly at run-time, dependent on the channel SINR values.

The noise variance calculation circuit 324 shown in FIG. 3 may be used to convert an input which is provided by the covariance matrix R₁ 123 of dimension (N_{R}×N_{R}), an input which is provided by the first G matrix 319 of dimension (N_{L}×N_{R}) and an input which is provided by the P matrix 321 of dimension (N_{L}×N_{L}) into an output which provides a noise variance estimation vector v 325 of dimension (N_{L}×1). Specifically, the signal processing in the noise variance calculation circuit 324 is based on Equations [8c]-[8f]. Note that in some alternative applications, the noise variance estimation vector v 325 may provide the inverse of the noise variances as expressed in Equation [40], in order to suit the downstream QAM demodulation processing.

$${( v )}_{i} = \frac{{\vert {( μ )}_{i} \vert}^{2}}{{( β )}_{i}} ( i = 1 , 2 , … , {N}_{L} ) \qquad ( 40 )$$

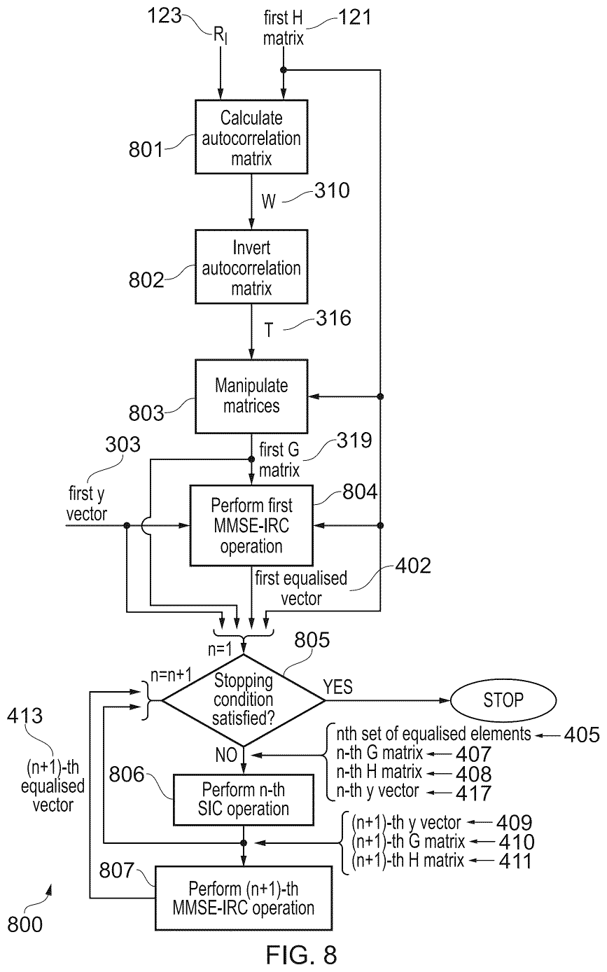

In summary, a particular manifestation of the present invention for MIMO equalisation may be described by the flowchart 800 of FIG. 8. The operation begins in 801, where an autocorrelation matrix, such as the autocorrelation matrix W 310 from FIG. 3, is calculated as a function of a covariance matrix, such as the covariance matrix R₁ 123 from FIG. 1, and a first channel estimate matrix, such as the first channel estimate matrix H 121 from FIG. 1. Following this, the autocorrelation matrix is inverted in 802, in order to generate an inverted autocorrelation matrix, such as the inverted autocorrelation matrix T 316 from FIG. 3. The inverted autocorrelation matrix and the first channel estimate matrix are manipulated in 803, in order to generate a first G matrix, such as the first G matrix 319 from FIG. 3. A first MMSE-IRC operation is performed in 804, which converts a first signal vector, such as the first signal vector y 303 from FIG. 3, the first G matrix and the first channel estimate matrix H into a first equalised vector, such as the first equalised vector 402 from FIG. 4. Following this, a loop over one or more MMSE-IRC-SIC stages is performed in 805, 806 and 807. More specifically, 805 evaluates whether a stopping condition has been met, such as having completed a fixed number of iterations through the MMSE-IRC-SIC stage loop. Here, a counter n is initialised with a value of 1 before beginning the loop and is incremented in each iteration of the loop.

If the stopping condition has not been met, then an n-th SIC operation is performed in 806. This converts an n-th set of one or more equalised elements, such as the n-th set of one or more equalised elements 405 from FIG. 4, that are taken from an n-th equalised vector, such as the n-th equalised vector 406 from FIG. 4, an n-th G matrix, such as the n-th G matrix 407 from FIG. 4, an n-th channel estimate matrix, such as the n-th channel estimate matrix H 408 from FIG. 4, and an n-th signal vector, such as the n-th signal vector y 417 from FIG. 4, into an (n+1)-th signal vector, such as the (n+1)-th signal vector y 409 from FIG. 4, an (n+1)-th G matrix, such as the (n+1)-th G matrix 410 from FIG. 4, and an (n+1)-th channel estimate matrix, such as the (n+1)-th channel estimate matrix H 411 from FIG. 4. Following this, an (n+1)-th MMSE-IRC operation is performed in 807, which converts the (n+1)-th signal vector, the (n+1)-th G matrix and the (n+1)-th channel estimate matrix into an (n+1)-th equalised vector, such as the (n+1)-th equalised vector 413 from FIG. 4. The loop is iterated until the stopping condition is satisfied in 805, whereupon the MIMO equalisation is completed.

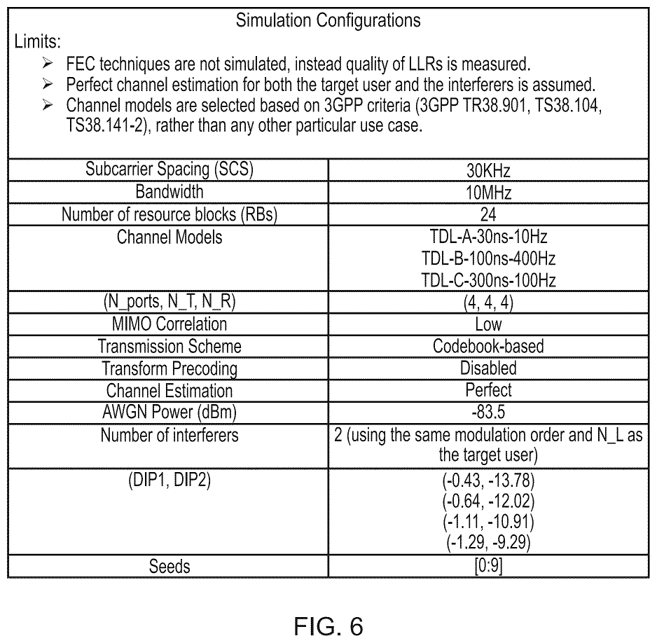

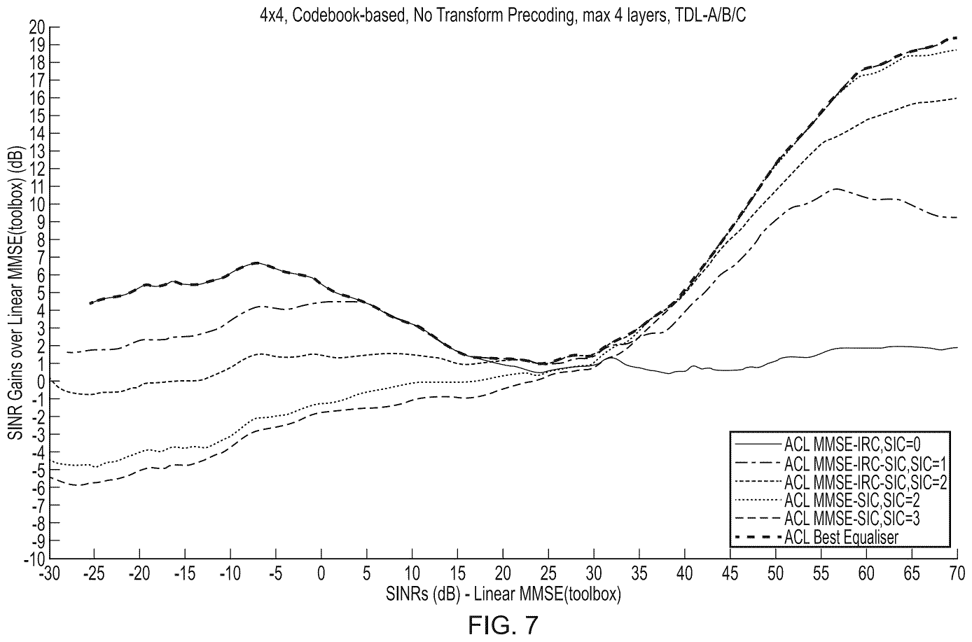

In accordance with some examples described herein, FIG. 6 presents an example simulation result based on the simulation configurations shown in FIG. 7 for the MMSE-IRC-SIC MIMO equaliser, where the SINR gain over the linear MMSE criterion vs. SINR is presented. Explicitly, as shown in FIG. 7, based on our initial simulations based on the 3GPP standard scenarios, the MMSE-IRC-SIC criterion has been demonstrated to have about 3 dB SINR gains over the linear MMSE criterion across a wide range of SINRs. In particular, the SINR gains are over 3 dB and even nearly up to 6.9 dB over MMSE criterion in the low SINR region and are over 3 dB and even nearly up to 19 dB over MMSE criterion in the high SINR region.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The present invention is herein described with reference to an integrated circuit device comprising, say, a microprocessor configured to perform the functionality of an equaliser computation. However, it will be appreciated that the present invention is not limited to such integrated circuit devices, and may equally be applied to integrated circuit devices comprising any alternative type of operational functionality. Examples of such integrated circuit device comprising alternative types of operational functionality may include, by way of example only, application-specific integrated circuit (ASIC) devices, field-programmable gate array (FPGA) devices, or integrated with other components, etc. Furthermore, because the illustrated embodiments of the present invention may for the most part, be implemented using electronic components and circuits known to those skilled in the art, details have not been explained in any greater extent than that considered necessary, for the understanding and appreciation of the underlying concepts of the present invention and in order not to obfuscate or distract from the teachings of the present invention. Alternatively, the circuit and/or component examples may be implemented as any number of separate integrated circuits or separate devices interconnected with each other in a suitable manner.

Also, the examples, or portions thereof, may be implemented as soft or code representations of physical circuitry or of logical representations convertible into physical circuitry, such as in a hardware description language of any appropriate type. Also, examples embodiments are not limited to physical devices or units implemented in non-programmable hardware but can also be applied in programmable devices or units able to perform the desired equaliser computation by operating in accordance with suitable program code, such as minicomputers, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as at least one than one. Also, the use of introductory phrases such as ‘at least one’ and ‘at least one’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘at least one’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. The word ‘subset’ refers to a selection of elements from a set, where that selection may comprise one, some or all of the elements in the set.

### REFERENCES

[1] “3rd Generation Partnership Project; Technical Specification Group Radio Access Network; Performance Requirements of MMSE-IRC receiver for LTE BS (Release 13)”, 3GPP TR 36.884 V13.1.0, September 2016.
[2] Yang, Lie-Liang. Multicarrier communications. John Wiley & Sons, 2009.
[3] Tavares, Fernando M L, et al. “On the potential of interference rejection combining in B4G networks.” 2013 IEEE 78th Vehicular Technology Conference (VTC Fall). IEEE, 2013
[4] Zhu, X. and Murch, R. D., 2002. Performance analysis of maximum likelihood detection 5 in a MIMO antenna system. IEEE Transactions on Communications, 50(2), pp. 187-191.

1-20. (canceled)

21. A multiple-input multiple-output, MIMO, equaliser circuit comprising:
a first input that receives a covariance matrix, Rₗ, a second input that receives a first channel estimate matrix, H, and a third input that receives a first signal vector, y;
an autocorrelation matrix calculation circuit operably coupled to the first input and the second input, wherein the autocorrelation matrix calculation circuit is configured to calculate and output an autocorrelation matrix W based on the covariance matrix, Rₗ, and the first channel estimate matrix, H;
a matrix inversion circuit, operably coupled to the autocorrelation matrix calculation circuit, configured to receive and invert the autocorrelation matrix, W, and output an inverted autocorrelation matrix, T;
a matrix manipulation circuit operably coupled to the matrix inversion circuit and the second input, wherein the matrix manipulation circuit is configured to receive and combine the inverted autocorrelation matrix, T, and the first channel estimate matrix, H, and output a first G matrix;
a first minimum mean square error interference rejection combining, MMSE-IRC, circuit operably coupled to the matrix manipulation circuit and the second input and third input, wherein the first minimum mean square error interference rejection combining, MMSE-IRC, circuit is configured to combine the first G matrix and the first channel estimate matrix, H, and the first signal vector, y, and output a first equalised vector; and
one or more MMSE-IRC-SIC stages, wherein the first MMSE-IRC circuit is concatenated with the one or more MMSE-IRC-SIC stages to form a chain and wherein a n-th MMSE-IRC-SIC stage in the chain comprises an n-th SIC circuit operably coupled to a n-th MMSE-IRC circuit, wherein the n-th SIC circuit is configured to:
receive an n-th set of one or more equalised elements that is selected from a n-th equalised vector, a n-th G matrix, a n-th channel estimate matrix H, a n-th signal vector y, and
output a ‘n+1’-th signal vector y, a ‘n+1’-th G matrix, and an ‘n+1’-th channel estimate matrix H; and
a ‘n+1’-th MMSE-IRC circuit operably coupled to the n-th SIC circuit, wherein the ‘n+1’-th MMSE-IRC circuit is configured to:
receive the ‘n+1’-th signal vector y, the ‘n+1’-th G matrix, the ‘n+1’-th channel estimate matrix H, and
output a ‘n+1’-th equalised vector; and
wherein the MIMO equaliser circuit is configured to output a final equalised vector x that is obtained by multiplexing an m-th equalised vector with each set of one or more equalised elements in a super-set comprising the first set of one or more equalised elements to an (m−1)-th set of one or more equalised elements and wherein a value of m varies between operations of the MIMO equaliser circuit at run-time.

22. The MIMO equaliser circuit of claim 21, further comprising a controller operably coupled to at least one circuit in the MIMO equaliser circuit.

23. The MIMO equaliser circuit of claim 22, further comprising a selection circuit operably coupled to the controller and configured to select the n-th set of one or more equalised elements from the n-th equalised vector under instruction by the controller and provide the n-th set of one or more equalised elements to the n-th SIC circuit.

24. The MIMO equaliser circuit of claim 23, wherein the controller is configured to use a first set of one or more noise plus interference power value(s) corresponding to the n-th equalised vector to instruct the selection circuit of those elements of the n-th equalised vector to select.

25. The MIMO equaliser circuit of claim 22, wherein the n-th MMSE-IRC-SIC stage in the chain further comprises a quantisation circuit operably coupled to and configured by the controller to replace each element in the n-th set of one or more equalised elements with a nearest quadrature amplitude modulated, QAM, symbol.

26. The MIMO equaliser circuit of claim 25, wherein the controller is configured to use a second set of one or more noise plus interference power value(s) corresponding to the n-th set of one or more equalised elements to replace each element in the n-th set of one or more equalised elements with the nearest QAM symbol.

27. The MIMO equaliser circuit of claim 21, wherein both the autocorrelation matrix W, and the inverted autocorrelation matrix, T, have a first dimension equal to a number of spatial streams, N_{R}, processed by the MIMO equaliser circuit and a second dimension equal to the number of spatial streams, N_{R}.

28. The MIMO equaliser circuit of claim 27, wherein the first signal vector, y, has a length equal to the number of spatial streams, N_{R}, the first G matrix has a first dimension equal to a first number of MIMO layers Ny detected by the MIMO equaliser circuit and a second dimension equal to the number of spatial streams, N_{R}, the first channel estimate matrix, H, has a first dimension equal to the number of spatial streams, N_{R}, and a second dimension equal to the first number of MIMO layers, Ny.

29. The MIMO equaliser circuit of claim 27, wherein the ‘n+1’-th signal vector, y, has a length equal to the number of spatial streams, N_{R}, the ‘n+1’-th G matrix has a first dimension equal to a ‘n+1’-th number of MIMO layers and a second dimension equal to the number of spatial streams, N_{R}, and the ‘n+1’-th channel estimate matrix, H, has a first dimension equal to the number of spatial streams, N_{R}, and a second dimension equal to the ‘n+1’-th number of MIMO layers, wherein the ‘n+1’-th number of MIMO layers is less than the n-th number of MIMO layers.

30. The MIMO equaliser circuit of claim 27, further comprising a controller operably coupled to at least one circuit in the MIMO equaliser circuit wherein the controller is configured to control an operation of the at least one circuit according to the dimensions of at least one matrix or vector input to or output from the at least one circuit, and wherein the number of spatial streams, N_{R}, and the first number of MIMO layers, N_{L}, varies at run-time.

31. The MIMO equaliser circuit of claim 21, wherein the autocorrelation matrix calculation circuit comprises:
a Hermitian transpose circuit operably coupled to the second input and operable to perform a Hermitian transpose that converts the first channel estimate matrix, H, into a Hermitian transposed, H2, matrix;
a first matrix multiplication circuit operably coupled to the second input and operably coupled to an output of the Hermitian transpose circuit and configured to combine and convert the first channel estimate matrix, H, and the Hermitian transposed, H2, matrix into a Hermitian H3 matrix; and
a matrix addition circuit operably coupled to the first matrix multiplication circuit and configured to receive the Hermitian H3 matrix output from the first matrix multiplication circuit and receive the covariance matrix, Rₗ, via the first input wherein the matrix addition circuit is configured to add the Hermitian, H3, matrix to the covariance matrix, Rₗ, and generate the autocorrelation matrix W.

32. The MIMO equaliser circuit of claim 22, wherein the matrix inversion circuit comprises:
a QR decomposition, QRD, circuit operably coupled to the controller and the autocorrelation matrix calculation circuit, wherein the QRD circuit is arranged to receive the autocorrelation matrix, W, and is configured by the controller to perform a QR decomposition on the autocorrelation matrix, W, and output an orthogonal unitary matrix, Q, and an upper triangular matrix, R; and
a Gaussian elimination circuit operably coupled to the controller and the QRD circuit and configured by the controller to perform Gaussian elimination to convert the orthogonal unitary matrix, Q, and the upper triangular matrix, R, into the inverted autocorrelation matrix, T.

33. The MIMO equaliser circuit of claim 32, wherein the Gaussian elimination circuit is configured by the controller to perform a Hermitian variation of the Gaussian elimination.

34. The MIMO equaliser circuit of claim 22 further comprising a first switch operably coupled to the controller and having a first switch input and a second switch input operably coupled to a covariance matrix generator circuit and an output operably coupled to the autocorrelation matrix calculation circuit;
wherein the first switch is selectably controlled by the controller to output the covariance matrix R₁ to the autocorrelation matrix calculation circuit,
wherein:
the covariance matrix R₁ is provided by the first switch input in a first mode of operation; and
the covariance matrix R₁ is provided by the second switch input in a second mode of operation, and
wherein the covariance matrix generator circuit uses a noise power scalar to generate the second switch input.

35. The MIMO equaliser circuit of claim 21, wherein the matrix manipulation circuit further comprises: a second multiplication circuit operably coupled to the matrix inversion circuit and configured to receive the inverted autocorrelation matrix, T, and the Hermitian transposed H2 matrix, and generate the first G matrix by multiplying the inverted autocorrelation matrix, T, and the Hermitian transposed H2 matrix.

36. The MIMO equaliser circuit of claim 21, wherein the n-th MMSE-IRC circuit further comprises:
a third multiplication circuit operable to convert the n-th signal vector y and the n-th G matrix into an n-th f vector; and
a fourth multiplication circuit operable to convert the n-th G matrix and the n-th channel estimate matrix H into an n-th E matrix; and
a division circuit operably coupled to the third multiplication circuit and the fourth multiplication circuit and configured to perform an element-wise division operation to convert the n-th f vector and the n-th E matrix into the n-th equalised vector.

37. The MIMO equaliser circuit of claim 35, wherein the matrix manipulation circuit further comprises a fifth multiplication circuit operably coupled to the second multiplication circuit and the third input wherein the fifth multiplication circuit is configured to receive the first G matrix and the first channel estimate matrix H and output a P matrix obtained by multiplying the first G matrix and the first channel estimate matrix H, and
wherein the MIMO equaliser circuit further comprises a noise variance calculation circuit operably coupled to each of the second multiplication circuit, the fifth multiplication circuit and the second input,
wherein the noise variance calculation circuit is configured to receive the covariance matrix Rₗ, the first G matrix and the P matrix, and to generate a noise variance vector, v, therefrom.

38. The MIMO equaliser circuit of claim 37, wherein the P matrix has a first dimension equal to the first number of MIMO layers, N_{L}, and a second dimension equal to the first number of MIMO layers, N_{L}.

39. A communication unit comprising a multiple-input multiple-output, MIMO, equaliser circuit comprising:
a first input that receives a covariance matrix, Rₗ, a second input that receives a first channel estimate matrix, H, and a third input that receives a first signal vector, y;
an autocorrelation matrix calculation circuit operably coupled to the first input and the second input, wherein the autocorrelation matrix calculation circuit is configured to calculate and output an autocorrelation matrix W based on the covariance matrix, Rₗ, and the first channel estimate matrix, H;
a matrix inversion circuit, operably coupled to the autocorrelation matrix calculation circuit, configured to receive and invert the autocorrelation matrix, W, and output an inverted autocorrelation matrix, T;
a matrix manipulation circuit operably coupled to the matrix inversion circuit and the second input, wherein the matrix manipulation circuit is configured to receive and combine the inverted autocorrelation matrix, T, and the first channel estimate matrix, H, and output a first G matrix;
a first minimum mean square error interference rejection combining, MMSE-IRC, circuit operably coupled to the matrix manipulation circuit and the second input and third input, wherein the first minimum mean square error interference rejection combining, MMSE-IRC, circuit is configured to combine the first G matrix and the first channel estimate matrix, H, and the first signal vector, y, and output a first equalised vector; and
one or more MMSE-IRC-SIC stages, wherein the first MMSE-IRC circuit is concatenated with the one or more MMSE-IRC-SIC stages to form a chain and wherein a n-th MMSE-IRC-SIC stage in the chain comprises an n-th SIC circuit operably coupled to a n-th MMSE-IRC circuit, wherein the n-th SIC circuit is configured to:
receive an n-th set of one or more equalised elements that is selected from a n-th equalised vector, a n-th G matrix, a n-th channel estimate matrix H, a n-th signal vector y, and
output a ‘n+1’-th signal vector y, a ‘n+1’-th G matrix, and an ‘n+1’-th channel estimate matrix H; and
a ‘n+1’-th MMSE-IRC circuit operably coupled to the n-th SIC circuit, wherein the ‘n+1’-th MMSE-IRC circuit is configured to:
receive the ‘n+1’-th signal vector y, the ‘n+1’-th G matrix, the ‘n+1’-th channel estimate matrix H, and
output a ‘n+1’-th equalised vector; and
wherein the MIMO equaliser circuit is configured to output a final equalised vector x that is obtained by multiplexing an m-th equalised vector with each set of one or more equalised elements in a super-set comprising the first set of one or more equalised elements to an (m−1)-th set of one or more equalised elements and wherein a value of m varies between operations of the MIMO equaliser circuit at run-time.

40. A method for successive interference cancellation, SIC, in a multiple-input multiple-output, MIMO, equaliser circuit, the method comprising:
receiving a covariance matrix, Rₗ, at a first input;
receiving a first channel estimate matrix, H, at a second input;
receiving a first signal vector, y, at a third input;
calculating and outputting, by an autocorrelation matrix calculation circuit, an autocorrelation matrix W based on the covariance matrix, Rₗ, and the first channel estimate matrix, H;
inverting the autocorrelation matrix, W, by a matrix inversion circuit, and outputting an inverted autocorrelation matrix, T;
combining the inverted autocorrelation matrix, T, and the first channel estimate matrix, H, by a matrix manipulation circuit, and outputting a first G matrix;
combining, by a first minimum mean square error interference rejection combining, MMSE-IRC, circuit, the first G matrix and the first channel estimate matrix, H, and the first signal vector, y, and outputting a first equalised vector; and
forming a chain by concatenating a first MMSE-IRC circuit with the one or more MMSE-IRC-SIC stages;
receiving, by a n-th SIC circuit, an n-th set of one or more equalised elements that is selected from a n-th equalised vector, a n-th G matrix, a n-th channel estimate matrix H, a n-th signal vector y, and outputting a ‘n+1’-th signal vector y, a ‘n+1’-th G matrix, and an ‘n+1’-th channel estimate matrix H;
receiving, by a ‘n+1’-th MMSE-IRC circuit, the ‘n+1’-th signal vector y, the ‘n+1’-th G matrix, the ‘n+1’-th channel estimate matrix H;
outputting a ‘n+1’-th equalised vector;
multiplexing an m-th equalised vector with each set of one or more equalised elements in a super-set comprising the first set of one or more equalised elements to an (m−1)-th set of one or more equalised elements, wherein a value of m varies between operations of the MIMO equaliser circuit at run-time; and
outputting, in response thereto, a final equalised vector, x.
